(19) United States
(12) Patent Application Publication
(10) Pub. No.: US 2005/0278187 A1
(43) Pub. Date: Dec. 15, 2005

(54) System and method for management of a certification program

(76) Inventor: Christopher L. Bobbitt, Vienna, VA (US)

Correspondence Address: BLANK ROME LLP, 600 NEW HAMPSHIRE AVENUE, N.W., WASHINGTON, DC, 20037, US

(21) Appl. No.: 10/940,736

(22) Filed: Sep. 15, 2004

Related U.S. Application Data
(60) Provisional application No. 60/578,817, filed on Jun. 14, 2004.

(51) Int. Cl. G06F 17/60

(52) U.S. Cl. 705/1

(57) ABSTRACT

A system and method for server-based management of a certification program. The certification program provides certification information to at least one subscriber, and is implemented on an application server that is searchable. Access privileges of a subscriber are based on existing subscription information and access rights as well as privilege flags are maintained in the server or at least one database in communication with the server. The server includes at least one processor, a memory and a plurality of agents logically connected to at least one database for providing requested certification information. The search results can be stored and later displayed by the subscriber for executing at least one certification-related procedure. Once the certification-related procedure is complete, the new certification information related to the subscriber can be maintained in at least one program database.

### RELATED APPLICATION

This application claims the benefit of U.S. Provisional Patent Application Ser. No. 60/578,817 for CERTIFICATION MANAGER, filed Jun. 14, 2004, the subject matter of which is incorporated by reference.

### FIELD OF THE INVENTION

The present invention is directed generally to improvements in managing certification training. More specifically, the present invention is directed to a simplified system and method to ensure that employees receive competent and quality certification training.

### BACKGROUND OF THE INVENTION

There has been an increased focus on training workers to do their jobs effectively and safely in many industries. Sometimes the training orients the worker to a new workplace or to new work responsibilities. Such orientation training may be performed once, but many times training must be performed repeatedly based on federal and local regulations governing conduct in the workplace.

For example, The Occupational Safety and Health Administration (OSHA) has implemented certification programs to insure that employers who are required to train employees in safety and health regulations, particularly the construction trades and general industry training courses, have a way to validate that instructors have received competent training and have been certified in specific knowledge areas.

Currently, however, the requirements for a company or person to conduct OSHA mandated training are too lax. As an example, emergency response regulations only require that instructors “be qualified to instruct employees about the subject matter that is being presented in training, and that “such trainers shall have satisfactorily completed a training program for teaching the subjects they are expected to teach.” The broad language of OSHA regulations provides an opportunity for many unscrupulous firms to offer certification training.

Moreover, if someone has received a degree in college, or even has taken a few safety courses, they can hang out a shingle and start selling “safety training,” without receiving adequate qualifications or certification for conducing such training. To that end, there appears to be an opportunity for a tremendous amount of abuse with regard to the quality of training offered to employers for training employees.

OSHA places the burden on the employer to insure that employees receive the proper level of training, according to their job duties. Employers understand the risks and the hazards involved in employees day-to-day work operations better than anyone. Thus, it is important that employers stay involved in the training as well as the certification process. Unfortunately, many employers don't know the necessary training regulations and don't have the time to invest in becoming professional training organizations.

Thus, there appears to be a need for an improved and simplified way for employers to ensure that employees receive and maintain quality certification training.

### SUMMARY OF THE INVENTION

To overcome limitations in the prior art described above, and to overcome other limitations that will be apparent upon reading and understanding the present application, the present invention is directed to a system and method for improved management of a certification program.

More specifically, the preferred embodiment of the present invention is directed to a method for server-based management of a certification program. The certification program provides certification information to at least one subscriber, and is implemented on a server that is searchable. The server includes at least one processor, a memory, and a certification management unit having a plurality of agents logically connected for providing certification information.

The method includes generating a user interface in a certification program environment that provides searchable certification information options based on predetermined access privileges granted to a subscriber. Once access privileges are granted, a subscriber can execute a search for certification information. The search results can be stored and later displayed by the subscriber for executing at least one certification-related procedure. Once the certification-related procedure is complete, the new certification information related to the subscriber can be maintained in at least one program database.

It is also contemplated by the invention that the certification program of the present invention includes implementing a notification procedure for providing a notification to a subscriber regarding the status of certification or re-certification as well as the occurrence of some other predefined condition.

Access privileges of a subscriber include authenticating the identity of at least one user as a subscriber and determining access to certification information based on existing subscription information. However, access privileges are also determined by evaluating use-of-rights tables and special access flags maintained in at least one database in communication with said server. Access privileges can include the right to read, delete, edit or output certification information obtain via the server. These access privileges are determined for every search query and are validated every time a subscriber renders a search request.

Other agents in the certification program can use the subscription information. The other agents include at least one agent related to notification services, at least one agent related to order services, at least one agent related to billing and collection services and at least one agent related to maintaining subscription information. Additionally, the subscription information can be used for providing access privileges to certification information for a plurality of users. For example, an employer maintaining a subscription may authorize several employees to receive certification training.

It is also contemplated by the invention that an e-mail function is implemented on at least one search screen presented to the user. The e-mail function can be used for communicating with other users or certification personnel while in the certification program environment.

The certification information that can be accessed by a user of the certification program includes account information, regulatory and state law information, order information, participant information, service request information, session information, trainer information, exam information and document management information. Additionally, the account information, the regulatory and state law information, the order information, the participant information, the service request information, the session information, the trainer information, the exam information and the document management information are able to be accessed through the context of other certification information being displayed to the user in the certification program environment.

By way of example, the regulatory and state legal data can be related to training and certification requirements for any one of the fifty U.S. states. The order information can be related to training materials or certification materials ordered by at least one subscriber. Additionally, the participant information can be related to other subscribers using the certification program. The training session information can include exam information as well as information related to individual exam questions. The trainer session information includes a list of trainers for a selected training session and the exam information can include a list of exam questions, answers and scores in the context of a particular test taker or a venue for a particular exam.

The certification information accessed by the user also includes trainer permit information, master trainer information, workshop information, contact information, supervisor information, report information, site permit information, violations information, notification service information, and link management information. The trainer permit information, the master trainer information, the workshop information, the contact information, the supervisor information, the report information, the site permit information, the violations information, the notification service information, and the link management information are able to be accessed through the context of other certification information being displayed to the user in the certification management environment.

By way of example, the trainer permit information can be related to a trainer permit for providing education services through the grant of a license by a regulatory body, wherein the trainer permit is granted for a particular training certification and jurisdictional area. The master trainer information can be related to certification training taught by a trainer or taught in a workshop. The supervisor information is provided to a user with a supervisor flag, and can be related to current users listed on a subscription. The site permit information is related to a site permit for providing training, wherein the site permit is related to a site location and a granting regulatory body in a jurisdictional area. The violations information can be related to violations of a site permit for a specific site location, wherein the notification information can be related to the scope, duration and delivery method of notification services. Additionally, the links management information can be related to web-based links to certification information, wherein the links are provided to users listed on a subscription.

Another embodiment of the present invention is directed to a system for providing a server-based management of a certification program for providing certification information to at least one subscriber. The system comprises a network connection for providing user access to said certification program, an authentication server, an application server and at least one database in communication with the application server.

The network connection can be an Internet connection or the like. The application server includes at least one processor, a memory and a certification management unit having a plurality of agents logically connected for providing the requested certification information. The database in communication with the server is used for storing at least certification information.

The agents within the certification management unit are operable for implementing within the certification program environment an account feature, a database feature, a participant feature, a service request feature, a session feature, a trainer feature and an exam feature. Additionally, the agents in the certification management unit are also operable for implementing within the certification program environment a trainer permit feature, a master trainer feature, a workshop feature, a contact feature, a supervisor feature, a report feature, a site permit feature, a violations feature, a notification feature, a document management feature and a links management feature.

The certification information stored in the database can include account information, regulatory and state law information, order information, participant information, service request information, session information, trainer information, exam information and document management information. The certification information stored in the database can also include trainer permit information, master trainer information, workshop information, contact information, supervisor information, report information, site permit information, violations information, notification service information, and link management information.

### BRIEF DESCRIPTION OF THE DRAWINGS

The accompanying figures best illustrate the details of the system and method of the present invention. Like reference numbers and designations in these figures refer to like elements.

FIG. 1 is a schematic diagram illustrating a system for implementing the certification program in accordance with an embodiment of the present invention.

FIG. 2 is a schematic diagram illustrating in more detail a web application server in accordance with an embodiment of the present invention.

FIG. 3 is a schematic diagram illustrating in more detail the certification management unit in accordance with an embodiment of the present invention.

FIG. 4 is a flow diagram illustrating in more detail the login feature of the certification program in accordance with an embodiment of the present invention.

FIG. 5A is a flow diagram illustrating the select address feature of the certification program in accordance with an embodiment of the present invention.

FIG. 5B is a flow diagram illustrating the generic record management feature of the certification program in accordance with an embodiment of the present invention.

FIG. 6 is a flow diagram illustrating the basic query feature of the certification program in accordance with an embodiment of the present invention.

FIG. 7 is a flow diagram illustrating the basic e-mail feature of the certification program in accordance with an embodiment of the present invention.

FIG. 8 is a screen shot of the main menu of the certification program in accordance with an embodiment of the present invention.

FIG. 9 is a flow diagram illustrating the relationship between database tables used by the certification program in accordance with an embodiment of the present invention.

FIG. 10 is a flow diagram illustrating the account feature of the certification program in accordance with an embodiment of the present invention.

FIG. 11 is a screen shot of an exemplary account document implemented by the certification program in accordance with an embodiment of the present invention.

FIG. 12 is a flow diagram illustrating the relationship between account database tables used by the certification program in accordance with an embodiment of the present invention.

FIG. 13A is a flow diagram illustrating the database feature of the certification program in accordance with an embodiment of the present invention.

FIG. 13B is a flow diagram illustrating the relationship between database tables used by the certification program for implementing the database feature in accordance with an embodiment of the present invention.

FIG. 14 is a flow diagram illustrating the orders feature of the certification program in accordance with an embodiment of the present invention.

FIG. 15 is a flow diagram illustrating the relationship between order database tables used by the certification program in accordance with an embodiment of the present invention.

FIG. 16 is a flow diagram that illustrates the participant feature of the certification program in accordance with an embodiment of the present invention.

FIG. 17 is a flow diagram that illustrates the participant feature of the certification program in accordance with an embodiment of the present invention.

FIG. 18 illustrates the relationship between participant database tables used by the tables certification program in accordance with an embodiment of the present invention.

FIG. 19 is a flow diagram illustrating the service request feature of the certification program in accordance with an embodiment of the present invention.

FIG. 20 is flow diagram that illustrates the relationship between service request database tables used by the certification program in accordance with an embodiment of the present invention.

FIG. 21 is a flow diagram that illustrates the session feature of the certification program in accordance with an embodiment of the present invention.

FIG. 22 is a flow diagram illustrating the relationship between session database tables used by the certification program in accordance with an embodiment of the present invention.

FIG. 23 is a flow diagram that illustrates the trainers feature of the certification program in accordance with an embodiment of the present invention.

FIG. 24 is a flow diagram illustrating the relationship between trainer database tables in accordance with an embodiment of the present invention.

FIG. 25 is a flow diagram that illustrates the exam feature of the certification program in accordance with the present invention.

FIG. 26 is a flow diagram that illustrates the exam feature of the certification program in accordance with the present invention.

FIG. 27 is a flow diagram that illustrates the relationship of exam database tables used by the certification program in accordance with an embodiment of the present invention.

FIG. 28 is a flow diagram that illustrates the document management feature of the certification program in accordance with an embodiment of the present invention.

FIG. 29 is a flow diagram that illustrates the document management feature of the certification program in accordance with an embodiment of the present invention.

FIG. 30 is a flow diagram that illustrates the relationship between document management database tables used by the certification program in accordance with an embodiment of the present invention.

FIG. 31 is a flow diagram illustrating in more detail the trainer permits feature of the certification program in accordance with an embodiment of the present invention.

FIG. 32 is a flow diagram illustrating the relationship between trainer permit database tables used by the certification program in accordance with an embodiment of the present invention.

FIG. 33 is a flow diagram that illustrates the master trainer feature of the certification program in accordance with an embodiment of the present invention.

FIG. 34 is a flow diagram illustrating the master trainer database tables used by the certification program in accordance with an embodiment of the present invention.

FIG. 35 is a flow diagram that illustrates the workshop feature of the certification program in accordance with an embodiment of the present invention.

FIG. 36 is a flow diagram illustrating the workshop database tables used by the certification program in accordance with an embodiment of the present invention.

FIG. 37 is a flow diagram that illustrates the contacts feature of the certification program in accordance with an embodiment of the present invention.

FIG. 38 is a flow diagram that illustrates the contacts feature of the certification program in accordance with an embodiment of the present invention.

FIG. 39 is a flow diagram illustrating the workshop database tables used by the certification program in accordance with an embodiment of the present invention.

FIG. 40 is a flow diagram illustrating the supervisor feature of the certification program in accordance with an embodiment of the present invention.

FIG. 41 is a flow diagram that illustrates the report feature of the certification program in accordance with an embodiment of the present invention.

FIG. 42 is a flow diagram that illustrates the report feature of the certification program in accordance with an embodiment of the present invention.

FIG. 43 is a flow diagram illustrating the report feature of the certification program in accordance with an embodiment of the present invention.

FIG. 44 is a flow diagram illustrating the report database tables used by the certification program in accordance with an embodiment of the present invention.

FIG. 45 is a flow diagram illustrating the site permit feature of the certification program in accordance with an embodiment of the present invention.

FIG. 46 is a flow diagram illustrating the site permit database tables used by the certification program in accordance with an embodiment of the present invention.

FIG. 47 is a flow diagram illustrating the violations feature of the certification program in accordance with an embodiment of the present invention.

FIG. 48 is a flow diagram illustrating the violations database tables used by the certification program in accordance with an embodiment of the present invention.

FIG. 49 is a flow diagram illustrating the notification service feature of the certification program in accordance with an embodiment of the present invention.

FIG. 50 is a flow diagram illustrating the notification service database tables used by the certification program in accordance with an embodiment of the present invention.

FIG. 51 is a flow diagram illustrating the links management feature of the certification program in accordance with an embodiment of the present invention.

FIG. 52 is a flow diagram illustrating the links management feature of the certification program in accordance with an embodiment of the present invention.

FIG. 53 is a flow diagram illustrating the links management feature of the certification program in accordance with an embodiment of the present invention.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced.

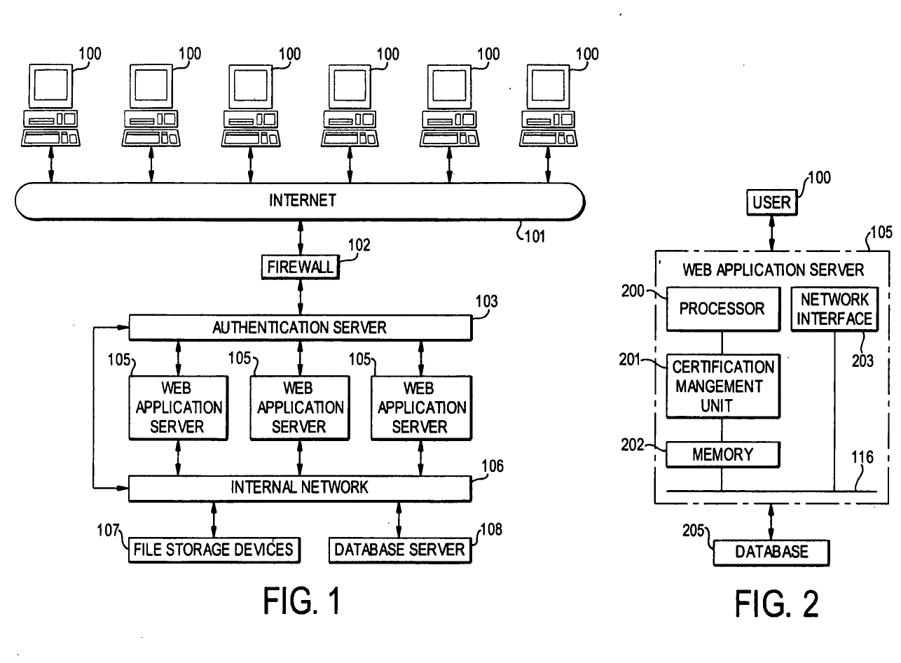

FIG. 1 is a schematic diagram illustrating a system for implementing the certification program in accordance with an embodiment of the present invention. In FIG. 1, the system includes, in pertinent part, an authentication server 103, several web application servers 105, a file storage device 107 and a database server 108. Protection for the system is provided by a firewall 102 connected between the authentication server 103 and the network connection 101. By way of example, a user 100 accesses the system through a network connection 101 such as the Internet using a general-purpose personal computer. The general-purpose computer can be any IBM compatible desktop computer or the like with an operating system such as Windows 95, Windows 98, Windows NT, Windows XP or other similar operating systems. The computer is equipped with a display monitor and a user interface such as a keyboard and/or point-and-click device. The computer is also equipped with a network interface that is well known in the art for achieving connection to another computer network via the Internet such as, but not limited to, a dial-up modem, a DSL connection, a cable connection or the like.

In FIG. 1, the user 100 accesses the authentication server 103 via the Internet 101. The authentication server 103 validates the user 100 as a subscriber to the system and creates a cookie on the user's 100 computer representing a session ID. The authentication server 103 then forwards the user 100 to at least one web application server 105 using a round-robin queue. The details of the web application server 105 will be discussed in connection with FIG. 2. Briefly, however, each web application server 105 includes a plurality of agents and at least one processor for processing search requests from a user 100 for certification information. The web application server 105 communicates with the database server 108 directly as one logical server based on the configuration data supplied to the database server 108 for accessing requested data in at least one database (not shown). Additionally, the web application server 105 communicates with the file storage devices 107 as one logical device. File requests are sent to a queue on the database server 108, and a separate file transfer program monitors the queue and transfers the files back and forth between at least one database (not shown) and the web application servers 105. Images are stored and retrieved from the file storage devices 107 in the same way as documents.

FIG. 2 is a schematic diagram illustrating in more detail the components of the web application server 105 in accordance with an embodiment of the present invention. As seen in FIG. 2, each web application server 105 includes at least one processor 200, a certification management unit 201 and a memory 202 all logically connected within the web application server 105 for processing requests by a user 100 for certification information. The processor 200 in the web application server 105 is also logically connected via the electrical bus 116 to a network interface 203 for establishing connection to the Internet. The certification data requested by a user is maintained in at least one database 205 in communication with the web application server 105.

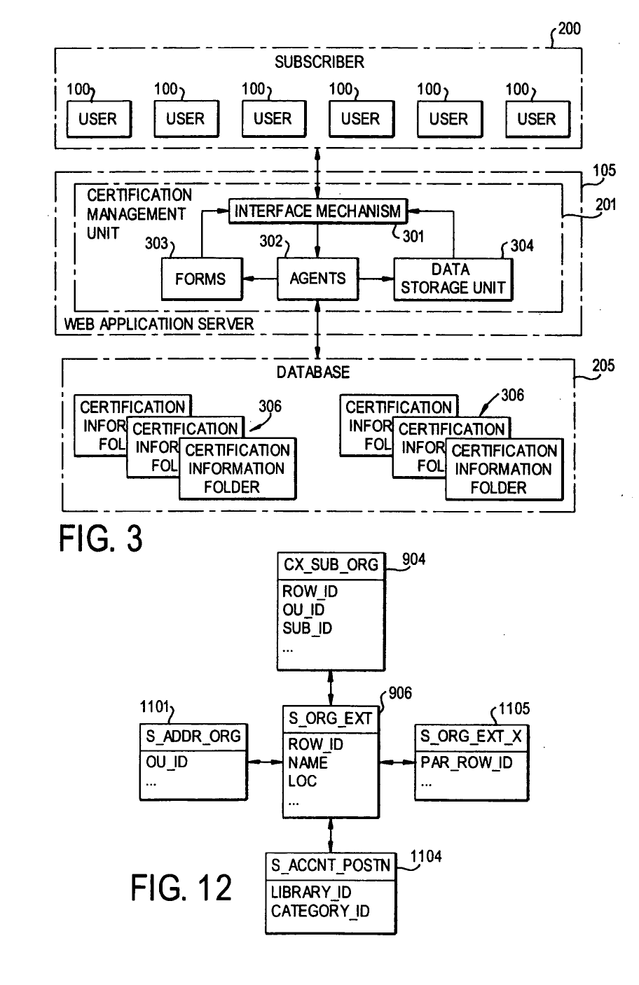

As seen in FIG. 3, a subscriber 200 to the certification program can include several users 100 that are required to have access to certification information. For example, a subscriber 200 may be a large corporate entity that requires certification training for several employees. The certification management unit 201 contains at least an interface or viewing mechanism 301, a plurality of agents 302, a plurality of forms 303, and a data storage unit 304. The agents 302 are computer-readable code that can be executed as part of a form 303, or directly via a URL. The forms 303 may also be requested via a URL through, for example a Domino application maintained in the server. The Domino application executes the agents 302 and renders the documents as HTML to the web browser via the forms. To that end, the agents 302 will assist in executing requests by users 100 for certification information. The details of the different agents 302 contemplated by the invention will be discussed throughout the description of the figures that follow.

The search forms 303 are presented to the user 100 via the interface mechanism 301 for executing search requests for certification information. The data obtained as a result of the search requests can be stored at least temporarily in the data storage unit 304 for display by a user 100. The database 205 in communication with the web application server 105 contains a plurality of certification application folders 306. The certification application folders 306 contain the certification information that is available to the user 100. By way of example, the certification information in the certification folders 306 can include account information, regulatory and state law information, order information, participant information, service request information, session information, the trainer information, and exam information. The different types of certification information available to the user 100 will be discussed in more detail in the description of the figures that follow.

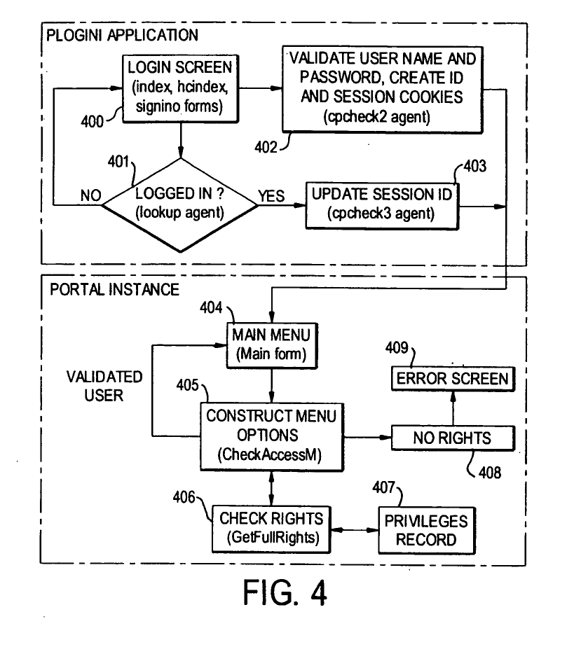

FIGS. 4-9 illustrate features of the certification program in accordance with the preferred embodiment of the present invention. FIG. 4 is a flow diagram illustrating in more detail the login feature of the certification program. In step 400, the user is presented with the certification login screen. The login screen is accessed via a home page of a certification program website. In step 401, upon accessing the page, an agent in the application server 105 determines whether the user is already logged in or not. This is typically dependent on the presence of the ID cookie installed on the user's computer. If the user is not logged in, the user will be required to enter login information via the login screen. Once the login information is entered, an agent will be executed to validate the login information, create an ID and session cookies, and determine the next available session for that user in step 402. However, if the user is already logged in, then in step 403 the user is directed to an agent that updates the session ID and determines the next available session. Session information is then forwarded to the user.

Once the user is authenticated, the session ID information is sent to the main menu via another agent in step 404. The main menu of the system is the first point of access to all of the features in the program. The main menu invokes every search form and most search agents, as well as provides an entry point for certification information. In step 405, the main menu executes an agent that constructs the main menu options based on the user's access rights and parameters derived from the subscription information maintained for a user. That information is stored in a privileges document stored in a memory location utilized by the certification program.

Generally, the functions for determining access rights are defined in a library maintained in the certification program that allows an agent to check a user's access rights to a specified service or area offered by the certification program. In each case, the agents return the rights to all services as a list. In fact, every agent uses those functions. There are two variations of that basic function: 1) GetRights (and the derivative GetFullRights which returns special access flags); and 2) CheckRights (and the derivative CheckFullRights which returns special access flags). The former works under the assumption that the user rights may or may not be cached into a “privileges” document. The latter assumes that the rights are cached, and proceeds to search for a privileges document to retrieve user rights. The rights checking process occurs at the beginning of every agent execution, after the user ID have been retrieved from a cookie written to the user's computer. From that point on, it proceeds (in the case of GetRights) as follows. The certification program establishes which system the user is accessing. This information is hard-coded into every agent and form in the system, and is passed as a parameter to the rights functions.

The system then searches for a matching privileges document in the application where it is running. If found, the application retrieves the rights and flags for the user. Many agents provide links to data in other systems, and so the rights information is needed when composing documents to determine whether links and information should be displayed or omitted. The agent also generates some navigational elements for the web page, depending on the context. The ChkRights function is similar to the above except a privileges document is not created. However, in step 406 if the privileges documents do not exist for a user, then the calling agent queries a database 205 for the necessary information, and creates a privileges document for the user in step 407. In step 408, if a user has no access rights information, then the user receives an error screen or is directed elsewhere in step 409.

The privileges document is an entity that is retained within each application and is keyed to a user based on the ID and session cookies that are stored on a user's machine. The document can be created automatically by the GetFullRights Msglib functions the first time that a user accesses an application, and the document is stored in a temporary memory in the application server. The privileges documents are deleted by a general “garbage collection” agent nightly, therefore privileges or access changes will typically be respected. While it is possible to modify someone's privileges after they have accessed the system and had their former privileges stored in this manner, the cached document will be removed within 24 hours. Since all agents execute those functions and all forms execute a CheckAccess agent before they display information, access to the system and a user's ability to see and manipulate information are constantly secured and validated.

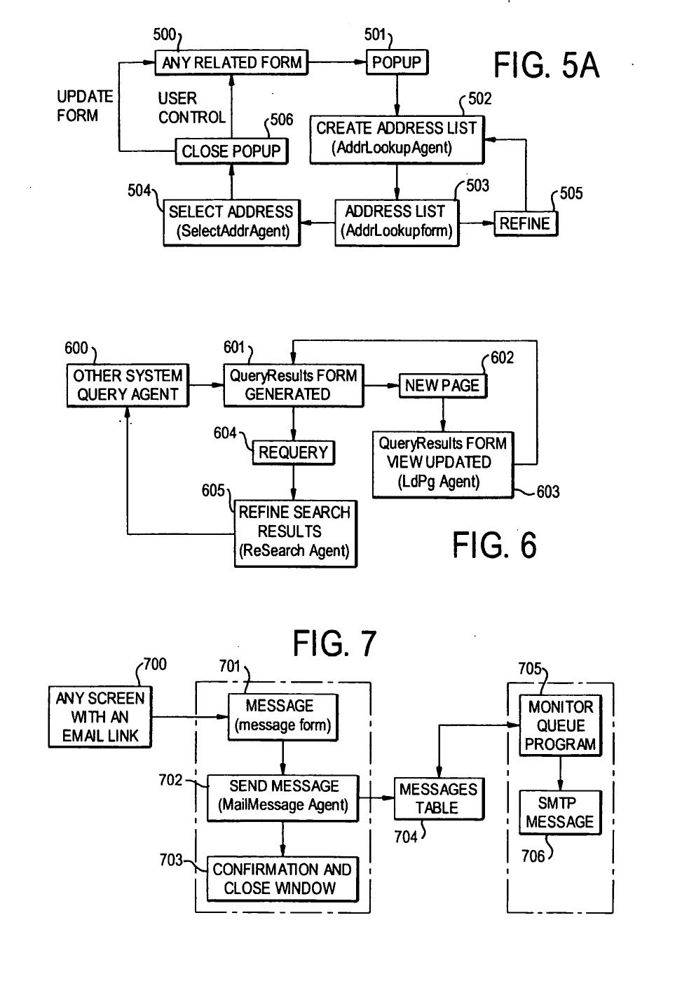

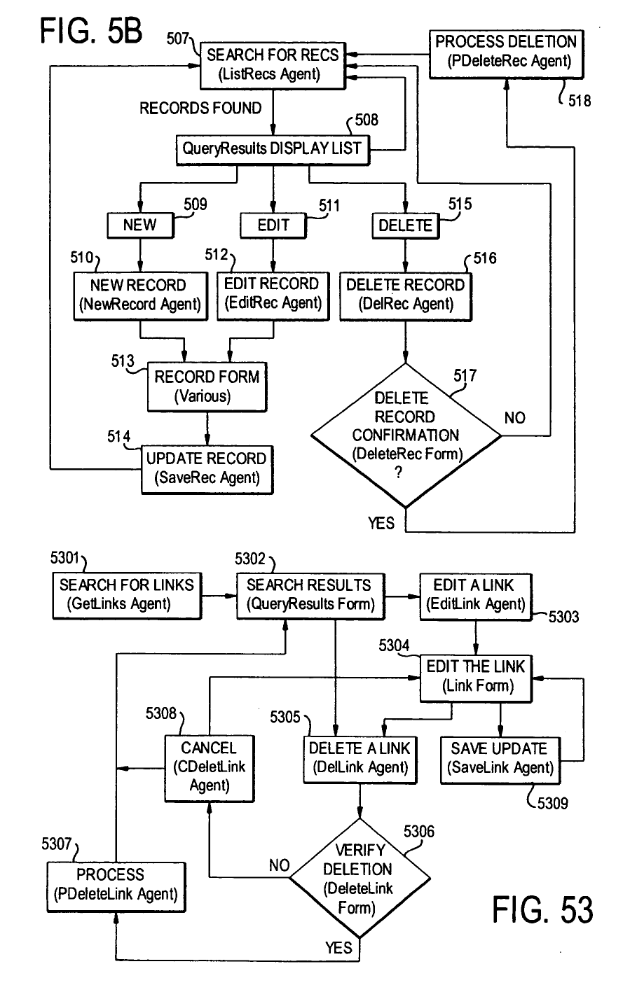

FIG. 5A is a flow diagram illustrating in more detail the address selection feature of the certification program. If a user has appropriate access rights, a user may choose to edit records maintained in the certification program. For example, when editing a program record while in the certification program environment, a selection option will be presented inviting the user to edit his/her address information. Selection of that option will execute an Address Lookup agent.

The AddressLookup agent is a generic agent for looking up addresses and for updating other types of records. Depending on the context in which the agent is called, the AddressLookup agent generates a list of alternative addresses available to the user related to a specific account. Since addresses per se are not restricted, theoretically any user can access this function. Practically speaking, however, the agent is only called when editing certification records.

In step 500, the user is presented with an edit form for editing certification information. In step 501, the AddressLookup agent is executed and a popup window is presented. The AddressLookup agent compiles a list of alternative address in step 502, and creates an AddressLookup form in step 503, which it loads in the popup window. The user then selects an account from a list presented in step 504, which is a predetermined list of addresses stored in the certification program. In the alternative, the user may refine the list of addresses presented in step 505.

The SelectAddress agent updates the form with the reference and values from the address record, closes the popup window and instructs the user's web browser to reload the form with the new data in step 506. The SelectAddress agent uses a Javascript to dynamically refresh the calling form so that it contains the new values. That new relationship is stored in the form on a temporary basis and will not be saved until the user saves the form.

FIG. 5B is a flow diagram that illustrates the generic record management feature of the certification program in accordance with an embodiment of the present invention. In step 507, links are generated by a menu agent and provided to the ListRecs agent. The links contain parameters that specify the type of records to be displayed. That mechanism can be used to edit database records as well. The types of records that can be handled by that mechanism are programmed into the ListRecs agent. The ListRecs agent is a general-purpose agent that returns a formatted list of records based on search parameters. The agent provides a standard way of viewing table records used in the certification program. Based on the search parameters, the agent queries the database, formats the results and displays the results using a standard QueryResults mechanism on a QueryResult form.

In step 508, a QueryResults form is generated by the ListRecs agent that contains the information in the table as well as links to all records to be added, edited or deleted. The form may be required depending on the type of record, which will reinvoke the ListRecs agent. From here, a user can create a record, edit a record or delete a record.

In steps 509-510, the user decides to create a new record by invoking the NewRec Agent. The NewRec agent is a general-purpose agent used for creating a record based on parameter values specified by a user. The agent is invoked from the QueryResults page. In step 511-512, the user decides to edit an existing record by invoking an EditRec agent. The EditRec agent is a general-purpose agent that allows a user to edit a record.

In either case, the type of record is coded as a parameter and coded into the corresponding agent. The parameters are fixed if they are determined to be allowed parameters. In step 513, the record created/edited is loaded into a temporary editing form along with the ID information and displayed. In step 514, the record can be saved by invoking the SaveRec agent. The agent takes the information entered in the form, as well as the saved parameter information, and updates or adds the record to the database. The SaveRec agent is also a general-purpose agent that allows a new or edited record to be saved to a database table. The agent uses the information stored in the record being created or edited to determine how to process the record.

On the other hand, in steps 515-518 the user decides to delete the existing record by invoking the DelRec agent. The DelRec agent is another general-purpose agent that creates a record deletion confirmation screen that is presented to the user. The agent is invoked by links generated by the ListRecs agent and embeds information about the record into the screen to allow a record deletion to be processed. The agent receives the record ID passed as a parameter, retrieves the record and generates the DeleteRec confirmation form. The DeleteRec confirmation form is composed with key information, and information to validate the deletion. The user confirms the deletion by invoking the PdeleteRec agent. The PdeleteRec is a general-purpose agent that is used to process a confirmed deletion by a user. Based on the key information, that agent deletes the appropriate record(s) in the database. If the user does not confirm the deletion or the deletion is complete, the user is returned to the original search screen.

As noted above, the agents used to implement the generic management feature are general-purpose agents that are used for managing records contained in database tables for all the features of the certification program. For example, the generic management feature can be implemented to manage records in the database feature of the certification program. To that end, an administrator having appropriate access rights can create, edit and delete records contained in database tables used by the certification program.

FIG. 6 is a flow diagram illustrating in more detail the basic query feature of the certification program. In FIG. 6, the user is presented with a query document via a query agent in step 600. The query document is essentially a freeform record containing all the formatted information as well as navigational elements to assist the user in finding the desired certification information. When a user executes a query, the query agent queries the database containing all of the data provided by certification program. The agent performs a query against a database and creates a query result document with an ID that represents the query executed in step 601. Within the query result document, the agent stores the query criteria and other information necessary to refine the query (fields that can be queried, etc.), as well as some HTML code for the proper display and refinement of certification information. The agent then calculates the number of records, and generates the HTML code necessary to navigate the results, and saves it to the document. The agent generates header information that will appear at the top of the screen. This header information contains site navigational elements, explanatory text, column headers and so forth.

In order to provide paged output of search results, a query caching mechanism is used by the certification program whereby the results are stored as pre-formatted HTML code in a temporary state on the application server. The query caching mechanism is a universal function of the certification program, which utilizes a unique property of a Domino web application environment. Basically, Domino allows for the creation of database records (which it calls “documents”). These documents are stored in an application server and can be very large, for example, up to 1 Gb in size each. Practically speaking, however, it is contemplated by the invention that the application server can maintain roughly 64 Gb of data per database. The documents are described both in terms of the data they store and how it is presented with “forms.” An extensive form calculation language can be embedded in the forms as “fields,” which execute when a form is converted into a web page. That formula language allows the certification program to format, compute, hide or reveal data at run time (among other things). The agent can then retrieve the result from the query record-by-record wrapping each result in the HTML code necessary for proper display. The user in steps 602-603 views the results of the query.

When the query results document is loaded, it is rendered based on the formulas defined in the related form. These formulas basically display the refine query, header, navigational and current data page elements. Since the results of a full search may be around 2 Mb in size, and a single page is only 50% of that, less data needs to be transmitted from the web server to the user for the display of certification information. Thus, results appear much faster. The query results are, for example, limited to the first 1,000 matching records and the queries work in a cumulative fashion.

The user can also decide to refine the search and re-execute the query, as in steps 604-605, by executing a re-search agent. The re-search agent is used to re-execute a query for refining a query result set. This agent is called from the query results form whenever the user elects to refine the results cached in that form. The re-search agent extracts the parameters stored in query results regarding the original query that was used to generate the results, and appends the new search parameters specified by the query result form. The agent then executes the appropriate search agent. The results are then presented as another query results form. In that way, the current query is cached, and the user can navigate to the previous query results as well.

The effect of cumulative queries, though, is that subsequent queries return fewer and fewer results. When such a refine query is executed, a new query results record is created, and the new query is assigned another ID. While that has the effect of storing quite a bit of data per user, it permits the user to readily navigate within the site. From query results, the user can typically “drill-down” to an individual record within the results.

The query results document also contains HTML links. Those links allow the user, to in effect, “navigate” through the data that was returned by the query. The functionality provided by the links includes three different overlapping mechanisms. First, storing a link to a point in the application where the user was immediately prior to that screen. Second, storing a separate document within the program itself thereby allowing it to be recalled for display without recreating it. Finally, storing, as part of the privileges document, a reference to the current screen. By operating that way, the certification program essentially leaves a trail everywhere the user goes within the program, and allows the user to retrace their steps. It also provides a handy facility for the application to allow the user to return easily to various other points within the program.

FIG. 7 is a flow diagram illustrating in more detail the basic e-mail feature of the certification program. The e-mail feature of the present invention is invoked by wrapping a link to the application within a Javascript function that opens a new window and presents a message form to the user. The link has two parameters: 1) the destination email address for the message; and 2) and the subject line. By embedding this information within the system invocation, abuse is minimized because a user can only send a message through the system to the person specified in the link and with the subject matter listed.

An agent translates (if necessary) the email address from an alias to a real SMTP email address, and then generates a record in a database table with all of the details of the message. The agent then sends a confirmation message to the user, and the window is closed. A separate program called ReMailerSMTP, monitors the message table on a separate server. When a new message appears in it, it retrieves the data and forms it into an SMTP message, which it then emails to the destination using the SMTP protocol. After successfully doing so, it updates the messages database table to indicate success (or failure). Therefore, message activity can be monitored, and messages can be resent manually if necessary.

With that in mind, In FIG. 7, the user is presented with an e-mail link to the portal mail application located on the same or another server in step 700. In step 701, the portal mail application presents a message form document to the user, which extracts the destination e-mail address and message subject, and determines the user's e-mail address. The user is then invited to enter a text message and click “send” when the text message is complete. In step 702, when the message is sent, a record is created in a database table with the message and a confirmation screen is displayed to the user in steps 703. In step 705, an application on a separate system monitors that message table, and generates an SMTP message in step 706. The table is updated to indicate when the message was sent.

The following is an exemplary list of search agents and functional components used for performing some of the basic functions of the certification program in accordance with the present invention.

Additional Basic Agents And Functions

CancelUpdate—A generic agent to cancel an update to a site/property (i.e. account) record. The agent can be invoked when a site/property record is being updated from the DSiteRec form. When called, it returns the user to the un-updated record.

LdPg—An agent used in conjunction with the QueryResults form (and the CaIcNavigator function of MsgLib) to permit the user to navigate the individual “pages” of results. The agent determines where in the cache the desired page is located, and places it in the visible part of the QueryResults form. It then recalculates what the navigational elements should be from that point and again updates the QueryResults form. Lastly, it loads a screen containing the updated QueryResults form.

ReloadDoc—A generic agent to reload a page. This agent reloads the current edited form, and is used as a basic mechanism to refresh a page by various agents.

MsgLib—A library of system-wide standardized functions that are used by all agents. The following is a list of functions that are provided by that library, by category:

Display Elements:

NotFound—Generates the specified error message in a standard format.

CopyRight—Generates a standard copyright notice for use by agents that generate screens.

StandardHeader—Generates a standard page header for agents that generate screens.

StandardFooter—Generates a standard page footer for agents that generate screens.

ExpiredUser—Standard message generated if the user's subscription is expired.

NotStartUser—Message generated if the user's subscription hasn't started yet.

NotFound2—Version of NotFound for popup windows.

CalcNavigator—Calculates the navigational elements on the bottom of QueryResults cached search results screens to allow the user to go through individual pages of the search results.

NotUser—Message generated if the user does not have a known subscription.

System Services:

SendEmail—Places information necessary to generate an email message into a database table. This table is monitored by an external application (SMTP Remailer), which generates and sends an email message via SMTP, and then updates the table to reflect that fact.

WriteCMREP—This function writes a record to a table used to track queries for use in generating reports. Each query that is performed by the system is assigned an individual transaction ID. If the user has reports feature access, then the query is written to this table with the transaction ID. If the user chooses to generate reports against the results of a query, the information in the report is based on this query.

GetReports—This function retrieves a list of reports that are available based on the location in the system of the user, and the access rights of the user.

Web Support:

getUID—Obtains the contents of the web site “ID” cookie, used to determine a user's privileges.

EnURL—Replaces spaces in the specified URL address with “+.”

DeURL—Replaces “+” signs in the specified URL address with spaces.

SpURL—Replaces spaces in the specified URL address with “%20.”

SaveURL—Retrieve the saved PREVURL field from the user's cached privileges document stored on each instance of the application.

GetURL—Saves the specified URL into the privileges document.

PREVURL—Calculates screen navigation links.

GetSession—Checks for the existence of a “Session” cookie, used to track a users specific session.

GetParams—Returns to a list format where the number of parameters determines the size of the list found. This is used in newer parts of the application.

Rights Management:

GetFullRights—Tests the user ID and extracts access information from the subscription, the subscription contact record and related privilege records.

ChkFullRights—This is a variation of GetFullRights that makes sure the rights are cached and other variables loaded.

GetRights—This is a version of GetFullRights that doesn't return certain rights flags.

ChkRights—This is a version of ChkFullRights that doesn't return certain rights flags.

Data Formatting:

StndPhone—Standardizes a string into a common phone number format.

StndSSN—Standardizes a string into a common social security number format.

ChkString—Checks a string that it is to be written to the database to assure that it does not contain single tick marks—which cause SQL queries to fail. Automatically reformats the string so that this will not occur.

LeftStr—Returns everything left of a particular point in a string.

RightStr—Returns everything right of a particular point in a string.

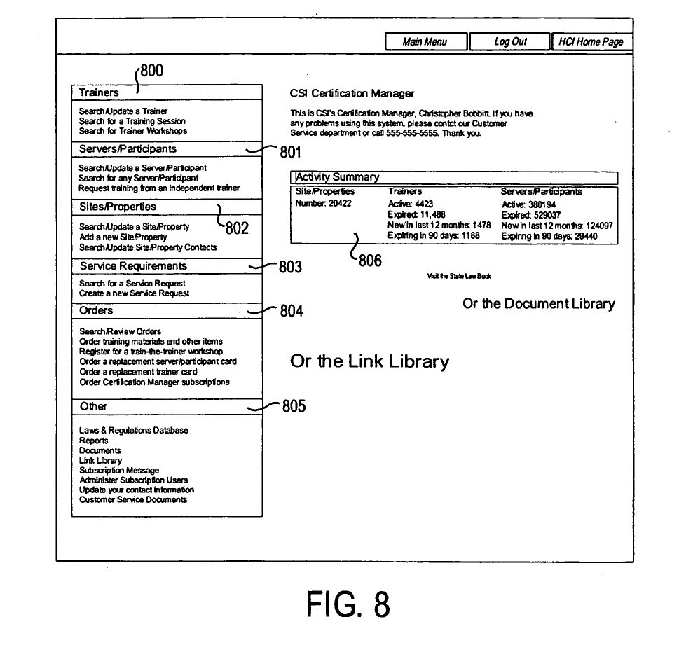

FIG. 8 is an exemplary screen shot illustrating in more detail a certification program environment presented to a user of the certification program. An interface feature provides for interaction between the certification program and the user, including the initial login screen to the display of certification information. As mentioned previously in FIG. 4, the purpose of the initial login screen presented to the user is to authenticate a user's initial attempt to access the system, or to validate an existing user's access rights. That is done through a series of screens that look different, but essentially function the same.

In FIG. 8, the login is completed and the user is presented with the main menu for the certification program. As seen on the left side of the screen the user is presented with several categories of search options 800-805 for obtaining certification information. Each category of search options 800-805 displayed on the left-side of the screen provides a list of searchable certification information available to a user based on the subscription information stored in the certification program. An activity summary 806 is also displayed. The activity summary 806 provides more detailed information regarding the activity of a particular user of the certification program listed on the subscription. Generally, there are three major user interface components for implementing the basic system of the certification program: 1) Address lookup functions; 2) the main menu; and 3) the query results caching mechanism.

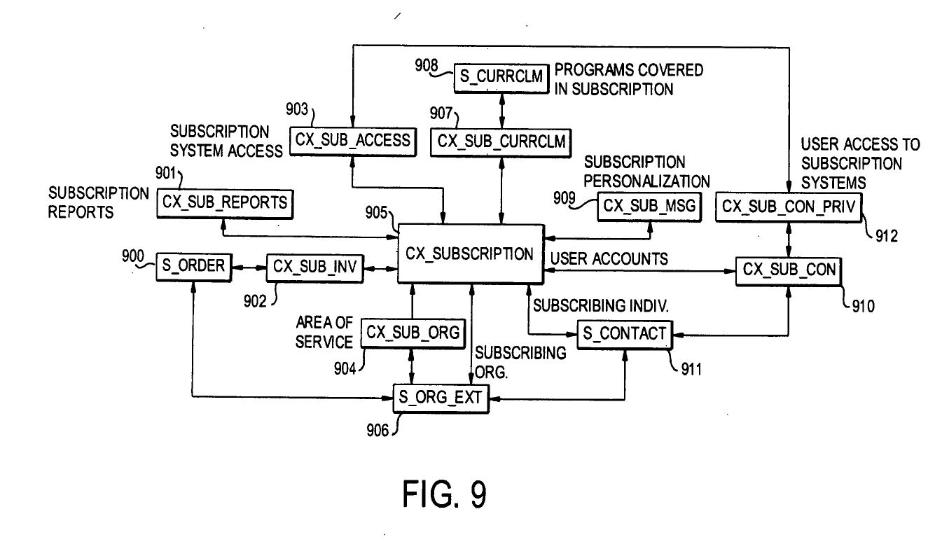

FIG. 9 is a flow diagram illustrating the relationship of the database tables used for implementing the subscription mechanism and the access rights mechanism of the certification program. To that end, the certification manger contains all the information necessary to implement an access control system, as well as support the ability to associate organizations and other entities with a subscription.

Access to certification information depends, to a large part, on the subscription information in the certification program related to the user, which is provided by a subscription mechanism. The subscription mechanism is one of the core elements for proper operation of the certification program. That is because the scope of the subscription determines the amount of information that will be ultimately available to a user. Additionally, the subscription mechanism helps provide a semi-automated process for offering, for example, billing services and the provisioning of services.

In FIG. 9, Table CX_SUBSCRIPTION 905 contains the subscription records. That table is the nexus of the subscription mechanism, and is also used for billing and service management. The subscription records in the table contain the basic information used to determine whether a user can gain access to the certification program during a certain period. All users listed under a subscription may gain access to the program if the subscription information in the table indicates that the subscription is valid.

Table CX_SUB_ACCESS 903 is the table that indicates the access rights of a subscription. Each subscription to the program will have a similar table record. However, it is contemplated by the invention that an administrator could grant access to a user, if that record does not exist. CX_SUB_CON 910 is the table related to subscription contact information. Each user attached to a subscription has a record in the table CX_SUB_CON 910. In other words, there is one record per user. The table CX_SUB_CON 910 is also used to help determine program features offered to a user as well as access.

As seen in FIG. 9, the table S_CONTACT 911 is in communication with table CX_SUB_CON 910 and CX_SUBSCRIPTION 905. Table S_CONTACT 911 is the primary table used to store contact information for users listed under a subscription. CX-SUB_CON_PRIV 912 is a table used to determine if an individual user has access to the program. Absence of a table record for an individual user means that no access is permitted to the certification program. CX_SUB_ORG 904 is a table related to accounts encompassed by a subscription. There is one record per account. That record is also used for determining the scope of services offered to a user.

Table CX_SUB_NV 902 is a table that relates to the subscription invoices that are generated for service setup and billing for a subscription, and table S_ORG_EXT 906 is used to store contact and account information. Table S_ORDER 900 is in communication with both table CX_SUB_INV 902 and table S_ORG_EXT 906 and provides order information to both record tables. Table S_ORDER 900 is the primary table used to store basic information regarding an order by a user or subscriber.

Table CX_SUB_CURRCLM 907 and table S_CURRCLM 908 are tables that relate to program information or curriculums covered by a subscription. In other words, those tables are used for determining the programs that a subscription covers during a query of the certification program. Table CX_SUB_MSG 909 is a table used to store information for personalizing the main menu. Table CX_SUB_REPORTS 901 is used for storing reports that are permitted under a subscription. If a report is not listed, even if it is available in the system, it will not be listed under as a user option.

By way of example, it is contemplated by the invention, that a user will purchase a subscription for services offered via the certification program. The subscription can be billed or changed on a recurring basis, before services are rendered. A subscription can be held by a corporate entity and be defined by an account number. Several users may be listed on an account. Services can be terminated upon a specific date if, for example, an invoice is not paid or by the explicit instructions by a subscriber. The subscription fee can be based on the number of users as well as the services offered. The service offerings are defined and distinguished from each other by the number of organizations encompassed in the service, the type of curriculums, and the defined set of search options. The subscription information is stored in a set of database tables in at least one database in communication with application server. The information that is obtained by a user can be personalized by using special messages and graphics. The information offered can also be particularly provisioned for each user listed on a subscription.

The services or information offered by the certification program are directly based on the organizations identified on the subscriptions. The services or information offered to an organization can be defined as the “service area.” The service area must be defined explicitly as part of the subscription process. Defining services explicitly eliminates the need to express a relationship with an organization as part of the data records. The only association that needs to be determined to achieve access to the certification program is related to the subscription. The subscription is also a financial mechanism in that it is the basis of the billing system. It becomes the reference point for the orders created for the purposes of invoicing and credit card payments. Additionally, the subscription is also the focal point for agents that control general notifications, and collecting information from a subscriber. In fact, just about every function of the certification program utilizes subscription information programmatically.

The rights management mechanism, as mentioned previously, is another core aspect of the invention for determining access to the program features along with the subscription mechanism. The rights management mechanism allows the administrator to specify a user's access privileges to information in each of the certification folders contained in at least one database. In other words, the rights management mechanism controls access to all the certification information offered by the certification program. Certification information is placed in a folder depending on the information-type. The following is a list of the different folders contained in the database for access by a subscriber:
1) Accounts;
2) Database;
3) Orders:
4) Participants:
5) Service Requests;
6) Sessions;
7) Trainers;
8) Exams;
9) Master Trainers;
10) Trainer Permits
11) Workshops;
12) Contacts;
13) Reports;
14) Supervisor;
15) Site Permits;
16) Violations;
17) Notification Service;
18) Document Management; and
19) Link Management.
   A user can be given the following rights to access certification information:
1) Read;
2) Edit;
3) Delete; and
4) Output.

The rights defined above are determined by the presence or absence of rights strings related to Read, Edit, Delete and Output privileges. For example, if a user has a rights string “REO” in the database with regard to, for example, the Accounts folder, then that user has the right to read, edit and print information in the Accounts folder. However, that user will not have the rights to delete information.

A subscriber's access rights to certification information in the program are defined by using some of the tables already discussed in FIG. 9. For example, tables CX_SUBSCRIPTION 905, CX_SUB_ACCESS 903, CX_SUB_CON 910 and CX_SUB_CON_PRIV 912. Assuming that a subscription permits access to certain certification information, the tables noted above define a user's actual access rights to the program. A user's access rights are defined each time there is a request for access to the program and the screen options are adjusted accordingly.

In addition to the subscription tables discussed in FIG. 9, there are special access flags (see below) that are stored in each user's records that further refine user access.

Special Access Flags:

1) Privacy Flag;
2) Site Only Flag;
3) Supervisor Flag;
4) Participant Portal Flag;
5) Trainer Portal Flag; and
6) Shared Access Flag

When the flags are set, individual screens can be modified irrespective of the subscription or rights an individual may or may not have to a particular service provided by the certification program. In some instances, having a flag checked provides access to systems that would not otherwise be available. Some flags may only have a subtle impact. For example, the Privacy Flag allows the user to see specific fields of data containing personal information that are not normally shared. The Site Only flag restricts the user to seeing only information related to their site. The Supervisor Flag is a hybrid flag. That flag provides an override in some areas of the program, while providing direct access to others. The Participant and Trainer Portal Flags allow access to areas of interest to a participant or trainer. The Shared Access Flag restricts access to what is appropriate if multiple users are sharing an account.

By way of example, rights to view data in the certification program are administered by creating records in database tables pertaining to a subscription and user rights. That is done using an application management interface or SQL script. Every record in the SQL script should reference a record in the table. Both subscription and user rights tables are used when administered within the certification program. Deleting a user account does not delete the related contact account. It only deletes that individual access to the certification program. Thus, deleting an individual user essentially opens a slot for a new user to gain access to the program under an existing subscription.

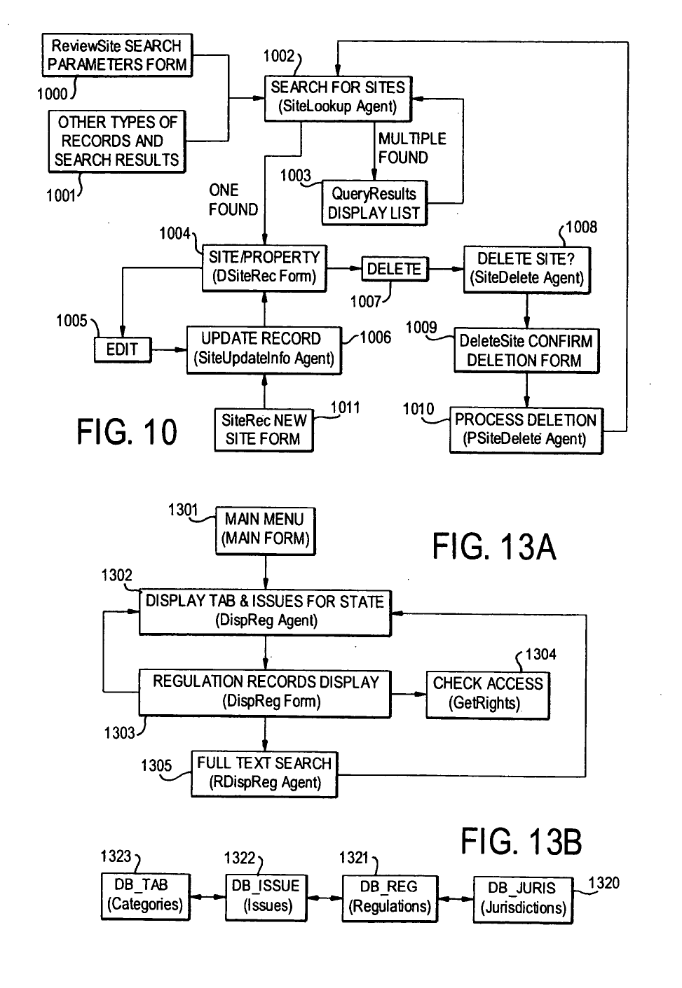

FIG. 10 is a flow diagram illustrating the account feature in accordance with an embodiment of the present invention. In FIG. 10, account information is retrieved by a user of the certification program through the Sitelookup agent, which is either invoked from a search form (i.e., ReviewSite form) in step 1000, or by “drilling down” from other related records displayed to the user in step 1001. The search form is generally the entry point to the account feature of the certification program. The account feature executes a screen for display based on data supplied by a user during the initial login process. When presented with the form, a user enters search parameters and creates a search query. In step 1002, the user executes the search, which invokes the Sitelookup agent.

The Sitelookup agent is the primary search agent used for retrieving sites/properties (i.e., account information) in the account feature. It is designed to be invoked either from the ReviewSite form, or from two different sets of URL parameters. It is invoked using URL parameters either from other forms (for example, a Contact form), or from links embedded in the results screens generated by other agents. In step 1003, if the query results in multiple records, the agent creates a QueryResult document by caching the list of the first 1,000 records found, and storing information necessary to refine the search. The user can refine the search result using the information provided in the QueryResult document, which will cause the QueryResult document to be updated and redisplayed.

In step 1004, if one record is found, the agent automatically opens a DsiteRec form containing the detailed relevant information regarding the record found. The DsiteRec form is the primary form used for editing a site/property. The DsiteRec form is always created using an existing record, and is populated with the current information regarding the account information found. The form also provides links to related information when applicable (assuming the user has access).

In steps 1005-1006, the user updates the account record displayed by editing the form. When the form is edited, the record is reloaded in the “edit mode.” From there, the user can select alternative contact and address records using popup agent applets, and update the information. When the changes are saved, the record update is made immediately by invoking the SiteUpdatelnfo agent. That agent is the general agent for adding a new site or updating an existing site/property. The agent performs the following functions, which are similar to the functions performed by all agents in the certification program that allow access to certification information. The agent first determines access rights. Next, it validates the data entered in various fields to assure that it is complete and in the correct format. Based on the form-type as well as the action specified, it either creates new records, or updates existing account records in the database.

In steps 1007-1010, the user can delete an account record that is being displayed. When a user decides to delete a record, a SiteDelete Agent is invoked. The agent is invoked from the site record itself, as embodied by the DsiteRec form. When invoked, it validates that the user has the appropriate access privileges, and determines a destination where the user should be sent if the deletion actually occurs (the context). The context information, along with basic information about the site being deleted, is placed in a DeleteSite form and presented to the user to confirm the deletion. After the deletion is confirmed, the record is removed from the subscription by a PsiteDelete Agent, and the user is sent to the destination determined by the agent. The destination is usually the starting point of the search process.

In step 1011, the user creates a new site record. If the user has appropriate access rights, the user is presented with a menu option that allows entry of a new account record. If selected, a new SiteRec form is created. That form provides fields for the user to enter information regarding an account and related primary contacts that are not already in the certification program. Additionally, if a user has appropriate access rights, they can change the association between a site record and an existing account record. When editing a record that relates to an account, there is an option presented that invites a user to change that association. Selecting that option, invokes the AcctLookup agent. The agent compiles a list of alternative accounts, and creates a form, which is then loaded in a popup window presented to the user. The user can then select an account from the list to update the form. Upon selection of the address, the agent closes the popup window and tells the user's browser to reload the form with the new data. The new data will not be written to the database until the user saves the form. The account selection feature is similar to the address selection feature already described in FIG. 5.

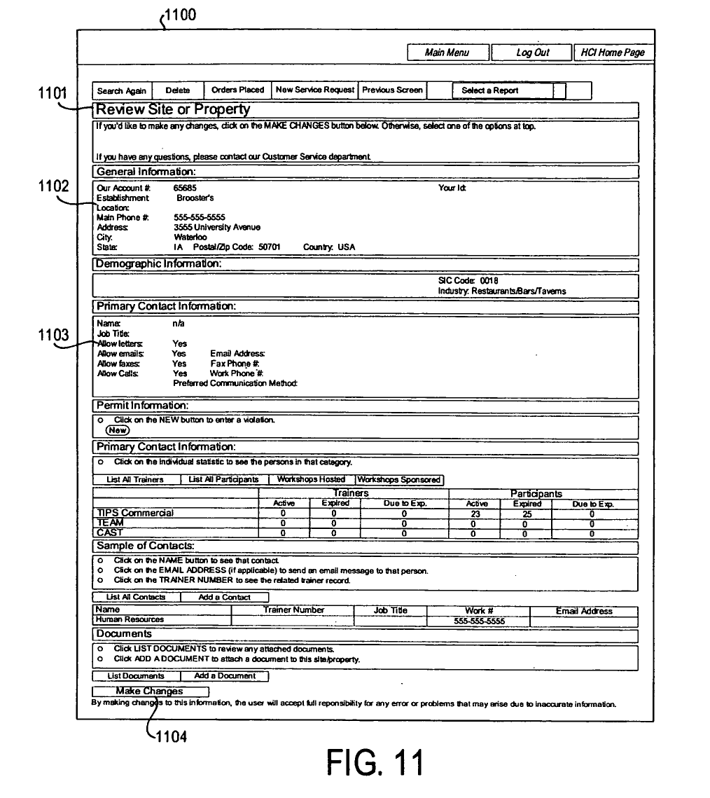

FIG. 11 is an exemplary screen shot of an account document in accordance with an embodiment of the present invention. FIG. 11 illustrates the typical account record or page 1100 that can be viewed by a user in the certification program environment. As seen in FIG. 11, the information is organized into sections. The individual sections and the content therein, may be adjusted, and displayed depending on the access rights of the user. The top section 1101 of the screen shot identifies the document as a site or property (i.e., account). The middle sections provide the user with general information 1102 regarding the account as well as primary contact information 1103. Additionally, many “inline” buttons are provided for access to related content, and many links are also provided for similar reasons. Links to related content are context driven; meaning that clicking on them will locate information related to the account. Changes to the record can be made by selecting the “make changes” option 1104 located at the bottom of the page.

The account feature of the certification program is composed of a series of program components as well as several database tables that provide the account information. FIG. 12 is a flow diagram illustrating the relationship between account database tables in accordance with an embodiment of the present invention. In FIG. 12, table S_ADDR_ORG 1101 is used to store address information for the program. Table S_ORG_EXT 906 is the primary account information table. The table 906 is used to store the basic contact and account information that is used by the certification program. A substantial portion of each record in the table 906 includes a link to related records in the account tables. For example, any account record ending in “ID.” Table S_ORG_EXT_X 1105 is an extension table that is used to store optional account information.

Table S_ACCNT_POSTN 1104 can be used to store workflow information related to an account as well as control who is reviewing account information. Table CX_SUB_ORG 904 controls information about an account that is specific to a subscription. For example, when an account record is deleted from the program, historical information is still retained in that table.

FIG. 13A is a flow diagram that illustrates the database feature of the certification program in accordance with an embodiment of the present invention. In step 1301, an option is displayed to a user that allows for access to the regulatory database. The user must have access to the database feature in order to have that option displayed. In step 1302, the user selects the option and invokes the DispReg agent. The DispReg agent is the main agent for the database feature and is the main point of entry for most users of the database feature. If the agent is invoked without parameters, it locates all the regulations that the user has access to, and composes a display of the information.

In steps 1303-1304, the agent validates access and determines what issues, tabs and regulations can be presented to the user. The agent then generates a display of the information using a DispReg form. The form is a temporary form used to cache and display retrieved regulatory data. The form also includes calculated display elements and retrieved data that facilitates navigation to related information. The display is generally organized by named tabs, and within each tab, by issue. The user is also presented with a text box for entering search criteria. All the data related to the current display is stored as data that is specific to the user.

In step 1305, the user clicks a display element, which invokes the RDispReg agent. The RDispReg agent is used to retrieve a database record from the database. It is designed to be invoked either from the main menu or from a link in another related data record. If the user performs a search, the RDispReg agent packages the search terms into a custom call to the DispReg agent, which searches the database. The user can also select a displayed element that results in a change of what is being displayed (i.e., a different tab, a navigational element or a jurisdiction). In that case, the DispReg is reinvoked and updates the existing DispReg temporary form and reloads it for display.

As mentioned previously, a user can gain access to the database feature directly from a link that invokes the DispReg agent. From here, the search of the database information is conducted as noted above. After conducting a search, the user can navigate back to the original calling point in the application.

FIG. 13B is a flow diagram illustrating the relationship between database tables used by the certification program to implement the database feature in accordance with an embodiment of the present invention. The primary database tables used for implementing the database feature are DB_JURIS 1320, DB_TAB 1323, DB_ISSUE 1322 and DB_REG 1321. Table DB_JURIS 1320 is the table used to store jurisdictions for which regulations and laws are maintained. Table DB_TAB 1323 is used to store information regarding the categories of regulations. Table DB_ISSUE 1322 is used to store information regarding the individual item within a category. For example, each issue is the title of the information contained within a tab. Table DB_REG 1321 is used to store information regarding actual regulations, which are specific to each jurisdiction and related to a given issue. For example, that information would be the text adjacent to the title or each section of a tab displayed to the user.

As with the document management feature, regulatory data can be confined to a specific domain. When a jurisdiction, category or issue is specified within a domain, all relevant regulations that reference those items are also within that domain. The practical result is that only users whose subscriptions are within that domain can see information contained with the database feature. If no domain is specified for a jurisdiction, category or issue, then all regulatory data is visible across domains. That is assuming there are no access rights restrictions to view the data.

Using the database feature, data is presented to the user with matching jurisdictions listed on the left side of the display screen and categories of information present across the top as “tabs.” An arrow located at the top of the screen indicates if more categories are yet to be displayed. However, information pertinent to a specific category and jurisdiction takes up the majority of the display screen. To change what is displayed, the user can select an alternative jurisdiction or category by selecting the corresponding tab. Additionally, a user can also enter search terms in a text box and re-execute a search.

When a search is re-executed, the results are displayed by restricting the tabs and jurisdictions available to just those that have regulations applicable to search criteria entered. If a user has administrative privileges, they can access the administrative menu. That function allows administrators to create and maintain information related to jurisdictions, categories, issues and regulations. The administrative function can be accessed form the main menu. When information is displayed using the administrative feature, the information is separated into columns that describe the record selected as well as ancillary information to assist in that identification. Regulatory records are specific to issues and jurisdictions. There are three main maintenance functions performed by the administrator-creating records, editing records and deleting records.

In general, the database feature allows users to readily access information regarding the regulatory environment based on a regulating entity. If the user has access to the program, whenever a regulating entity is referenced, there is generally a link that allows the user to retrieve the relevant information. The purpose of the database feature is to enhance the human resource management and regulatory compliance aspects of the certification program by making the necessary state regulatory information readily available.

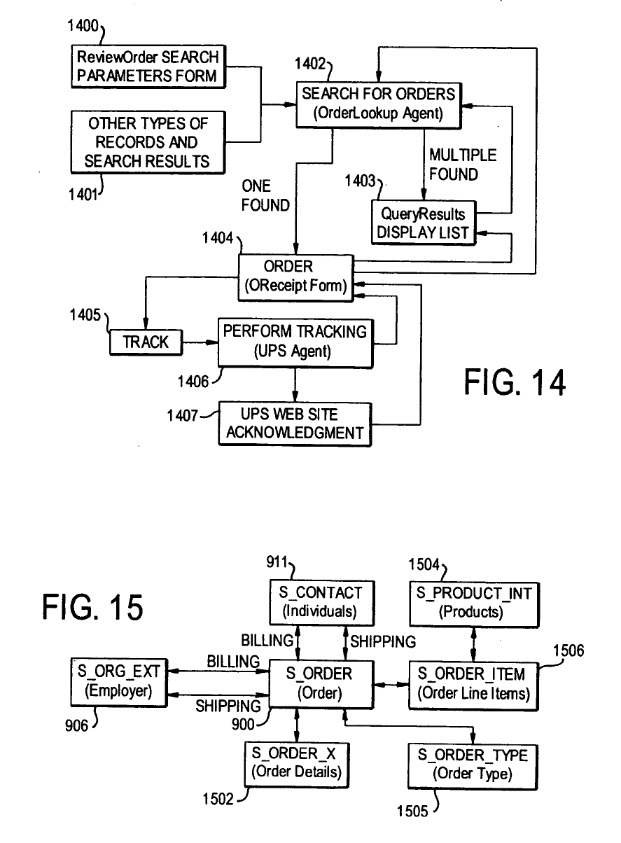

FIG. 14 is a flow diagram illustrating the orders feature in accordance with an embodiment of the present invention. In FIG. 14, the order information is retrieved through the OrderLookup agent, which is either invoked from the search menu (i.e., ReviewOrder) in step 1400, or by a “drilling down” from other related records in step 1401. That search menu allows the user to enter a variety of search criteria, and execute a search of the orders system against those criteria. That feature is available to the user after validating the access rights to the orders information. In step 1402, the user executes the search. In step 1403, if the search returns multiple results, the agent creates a QueryResult document caching the list of the first 1,000 records found during the search. The agent also stores the information needed to refine and redisplay the search results. In step 1404, if a single document is found, the agent automatically opens an OReceipt form that contains all the relevant information for that orders record. The OReceipt form is the primary form for viewing an order record. The OrderLookUp agent automatically creates a document using this form if a single document is located as a match to the user's query.

In steps 1405-1406, if UPS tracking information is available, then an option is available that allows the user to request tracking information. Selecting that option causes a screen to be composed via the UPS agent to confirm the tracking number. The UPS option is provided as a link on the OReceipt form to execute an agent. The agent extracts the UPS package ID from its calling parameters, and presents a form containing the tracking number. When a “Track package(s)” button is selected, the system transmits the form to UPS, which generates a response document that details the transit of the package. In step 1407, a customized confirmation message is displayed on the user's screen.

The orders feature of the certification program is a value-added function that allows the user to access information regarding the orders placed as well as a function to place new orders. The feature also provides order information in context to other records. For example, whenever a record is displayed that is related to orders, a link is generally provided that allows the user to retrieve other related information.

Additionally, if the user has access, the main menu provides a sub-menu allowing the user to see existing orders, and place new ones for a variety of types of products. When there are more than 10 orders found, the results are organized by “page” and there is a series of navigational controls at the bottom of the page, which allow the user to navigate through the results. The paging mechanism for this search is similar in function to the paging mechanism offered in most features of the certification program. Search results can be sorted by, for example, alphabetical, ascending or descending order. The order record is displayed as a straightforward receipt. The user is not expected to interact with the information, instead it is simply a record of the transaction. For the most part this information is static. However, if a shipping tracking number is available, then it will be highlighted as a link. Selecting this link brings up a form to initiate a package trace with UPS.

FIG. 15 is a flow diagram illustrating the relationship between order database tables in accordance with an embodiment of the present invention. In FIG. 15, table S_ORDER 900 is the primary table used to store basic information regarding orders and table S_ORDER_X 1502 is a table used to store more detailed information related to orders. Table S_ORDER_ITEM 1506 is a table used to store line item information associated with user orders. Table S_ORDER_TYPE 1505 is a table used to store information related to order-types available to users. Finally, table S_PROD_INT 1504 is used to store information related to the products ordered. Table S_ORG_EXT 906 provides contact and account information to the order feature of the certification program.

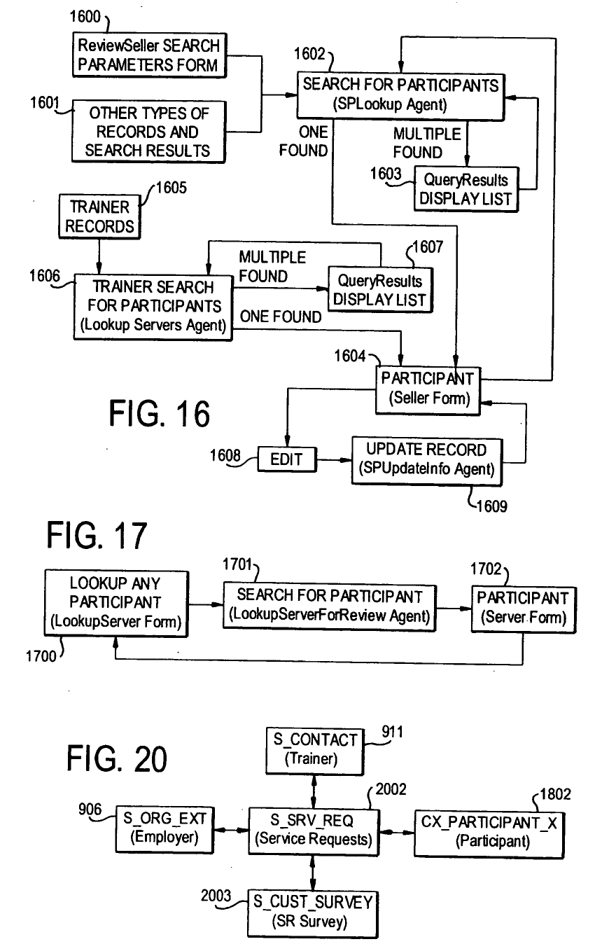

FIG. 16 is a flow diagram that illustrates the participants feature in accordance with an embodiment of the present invention. Participant information is retrieved through the SPLookup agent, which is either invoked from a search form (i.e., ReviewSeller) in step 1600 or by “drilling down” from other related records in step 1601. The ReviewSeller form is the point of entry for most users of the participants feature of the program. The agent draws a search screen for users and invites them to enter search criteria. After the user enters values in the various fields, and selects the search option, the SPLookup agent is called to execute the search in step 1602.

The SPLookup agent is the primary search agent used for retrieving participants information in the program. As previously stated, the participants feature is design to be invoked either from the ReviewSeller form (whereupon it searches the calling form for its parameters), or from two different sets of URL parameters. It is invoked using URL parameters either from other forms (for example, a Contact form), or as links embedded in the results screens generated by other agents. The agent performs the following major functions: (1) validating access rights (and therefore, what other functions are available); (2) provisioning of updating the result set through re-queries when the underlying data changes; and (3) generating of a search results customized to the access rights of the user. The last function uses the system-wide mechanism for caching search results, which allows the user to page through results, and interact with the data through those pages. The second function ensures that if the underlying data is changed in some fashion, the cached result set is updated without updating the whole cache. Most agents providing access to certification information in the program environment perform a similar function.

If the search returns multiple results, then in step 1603, the agent creates a QueryResults document caching the list of the first 1,000 records found during the search. The agent also stores the information needed to refine and redisplay the search results. If the user decided to refine the search, the QueryResults document is updated and displayed. If only one document is found, then in step 1604 the agent automatically opens a SellerRec form containing all the relevant information about the participant record. The SellerRec form is the primary form used for viewing and editing a participant record. This form is always created using an existing record, and is populated with the current information regarding that participant. The form also provides links to related information when applicable.

Altenatively, in steps 1605-1607 a user can conduct a separate search related to trainers by the user using the Lookup Servers agent. That search approach is used to find all participants in the database that are related to a specific trainer. That search can produce different results than the search related to participants. Lookup Servers is a specialized version of the SPLookup agent that is expressly designed to generate a list of participants relevant to a trainer. The tables used in that sort of query are different than other queries, and using an alternative agent results in a more efficient search. Further, the results are formatted to be more relevant to a specific trainer.

When a record is displayed, it acts as the nexus for a range of links and operations available to a user. For example, that is the point that allows the user to edit a record found. In step 1608, the user edits a record. When a record is edited, the record form is reloaded in the “edit mode.” From there, the user can select alternative contact and address information using a popup applet, and update the information. When the changes are saved, the record update is made immediately by the SPUpdatelnfo agent in step 1609. The SPUpdatelnfo agent is an agent used to save an edited participant record. When invoked, the agent first ensures that the user has the appropriate access rights to change participant information. Next, it validates that the data entered in various fields is complete and in the correct format. The agent then updates the existing CX_PARTICIPANT_X record. That system can be used to associate a participant with a new location as well.

FIG. 17 is a flow diagram that illustrates another embodiment of the participants feature in accordance with another embodiment of the present invention. Specifically, FIG. 17 illustrates how a user can locate a participant in the program. In FIG. 17, a user can locate any participant listed in the program by selecting a corresponding option on the main menu in step 1700. By selecting that option from the main menu, a LookupServer form is presented to the user. The LookupServer is a search form that allows users to search all participant records regardless of where they are employed, or their association with a subscription. This is a general search function that can be used to validate any individual's training status. As a result, the information returned is the minimum necessary to validate participant information. Few details are provided beyond verification of training, and current address information. To perform a query, further, the user must have either the employee's social security number or a training ID.

In step 1701, the LookupServerforReview agent is invoked and searches all participant records. The search is conducted only after the user has been validated. In step 1702, the participant record found is displayed using a Server form. The Server form is used to display participant information and is used by the LookupServerforReview agent to display any participant record found matching the criteria entered in the LookupServer form.

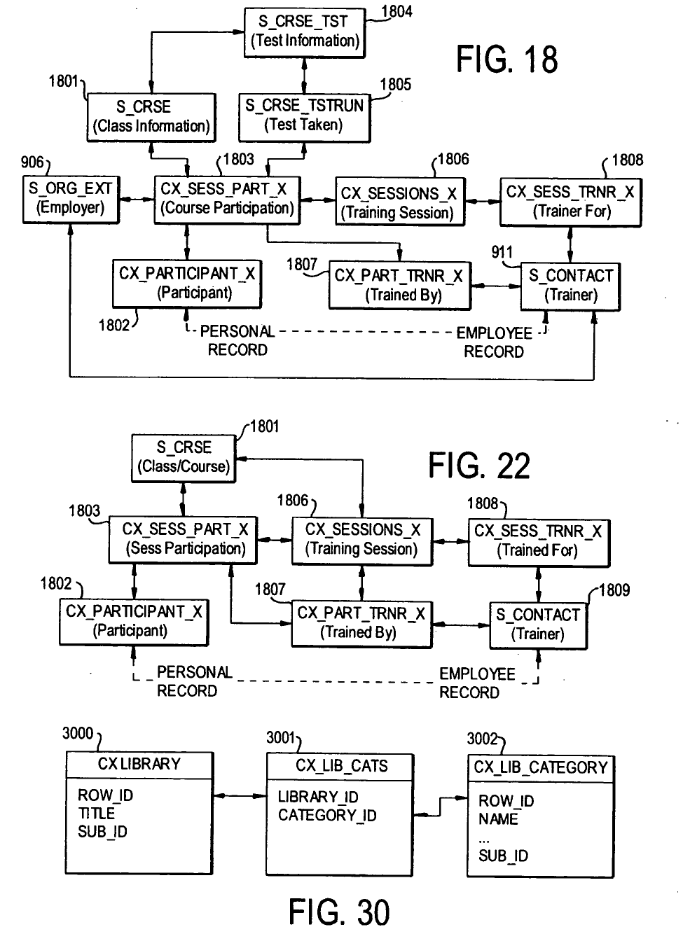

FIG. 18 illustrates the relationship between participant tables used by the certification program in accordance with an embodiment of the present invention. In FIG. 18, The primary tables used for the participant feature of the certification program are tables CX_PARTIC1PANT_X 1802, CX_SESS_PART_X 1803, and CX_PART_TRN R_X 1807. CX_PARTIC1PANT_X 1802 is the primary table used to store basic information related to individuals who have participated in a training session. That table stores personal information, but can include current work information as well. Table CX_SESS_PART_X 1803 is used to store a record every time a user participates in a class or course. That table captures information about the status of the employee at that time, and is immutable. However, the table can also track a progression of when and where an individual was employed, and how they were regulated at the time. Table CX_PART_TRN R_X 1807 is used to store a direct relationship between a trainer and a user that participated in a class or training session taught by that trainer. That information is used by the Lookup Servers agent.

A participant may be involved in more than one course. That situation is reflected by a table record stored in the table CX_SESS_PART_X 1803 for every act of participation by a user. The information captured in those records reflects the status of the individual at the time of the training, and is static. Information related to their current status is stored in the CX_PARTIC1PANT_X 1802 record. Some information from CX_SESSIONS_X 1806 is utilized in the display of participant records, which is a primary component of the session feature of the certification program along with table CX_SESS_TRNR_X 1808. The CX_PART_TRNR_X 1807 table is used to store redundant information related to the relationship between a trainer and a participant.

FIG. 18 also illustrates other tables in communication with the above tables that are not necessarily considered part of the participant feature of the certification program. Those tables are included in FIG. 18 to illustrate the overall context of the database tables used by the certification program. For example, a user may have both a trainer record in the table S_CONTACT 911, or a participant record in the table CX_PARTICIPANT_X 1802. That relationship is reflected in the system with a link to both types of records. If a user has a more complex relationship, then that information needs to be in both records. That relationship may also require access to contact and account information, which is provided in table S_ORG_EXT 906. Additionally, a participant may require information related to future classes and tests as well as tests that have already been taken. That information is made available in tables S_CRSE 1801, S_CRSE_TST 1804 and S_CRSE_TSTRUN 1805.

The participant feature is available to all subscribers who minimally have “Read” access privileges to the participant feature of the certification program. Depending on access rights, a user may have fewer or more privileges to manipulate participant information being reviewed by a user. Access to participant information can be provided within the context of other information. The relationship that participants information has to other data in the program is as important as access to a participant record itself. By providing relevant access to participant data from other types of records, and vice versa, the user is able to easily navigate through the certification program environment to obtain certification information.

When presented with a search screen while using the participant feature, there are several requirements for entering data. All search criteria fields are case-insensitive. All searches involving text are “wildcarded,” meaning that if the user enters a partial string, any records having a field that contains that string will be returned with the results. A participant number is the unique number that is assigned to each participant in the system and a user can search all participants in the program, with the appropriate access rights.

When a search is executed, a result screen is created based on the search criteria. If more than 20 participants are found, the results are organized by “page” and there is a series of navigational controls at the bottom of the page that allows the user to go through the results. The paging mechanism for this feature is the same for all features in the certification program. The results can be sorted in alphabetic, ascending or descending order. The information that is provided to the user is organized into sections and the individual sections and the content therein may be adjusted, displayed or not depending on the access rights of a user. Many links may also be provided for accessing related information. Options for accessing data may or may not be provided at the top of the record presented to permit using this record in context. As with other links, the links presented when using the participant function are context driven.

The participants feature of the certification program includes a tool that allows employers to validate the training status of individuals. The entire participant database can be searched, regardless of association or relationship. Because the purpose of this function is simple, the information returned by this function is minimal. The search option is obtained by selecting an option to “Search for Any Server/Participant” that is located on the main menu. The user must have at least “Read” access privileges to the participants feature.

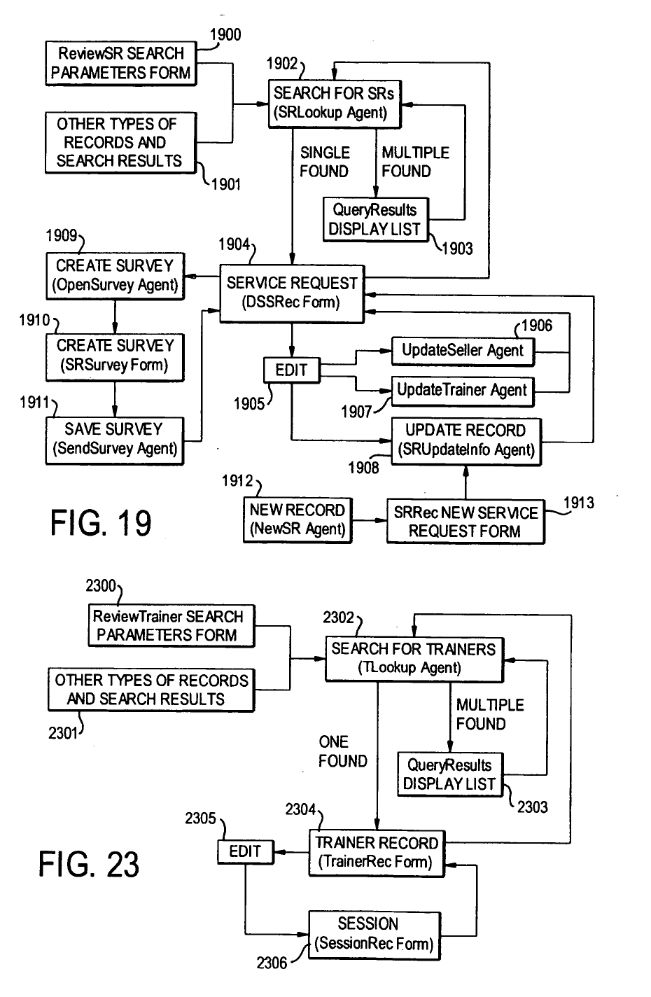

FIG. 19 is a flow diagram illustrating the service request feature of the certification program in accordance with an embodiment of the present invention. In FIG. 19, service request information is retrieved through the SRLookup agent, which is either invoked from a search form ReviewSR in step 1900, or by “drilling down” from other related records in step 1901. ReviewSR is a point of entry for most users of the service request system. This component draws a search screen for users and invites them to enter search criteria.

After the user enters values in the various fields, and clicks on a search button, the SRLookup agent is called to execute the search in step 1902. The agent creates a QueryResults document caching the list of the first 1,000 records found that match the search criteria entered by the user in step 1903. If the user chooses to refine the search results, the QueryResults document is updated and redisplayed. If a user wished to open a document, the OpenSR agent is used to create a document using a DSSRec form. DSSRec form is the primary form used for viewing and editing an individual service request. This form is always created using an existing record, and is populated with the current information regarding a specified service request. In step 1904, if a single record is displayed, the SRLookup agent automatically opens the record using the DSSRec form as noted above.

In step 1905, the user can elect to edit a record that is retrieved from the search. If the user edits the record, the record form is reloaded in the “edit mode.” In steps 1906-1907, the user can select alternative contact information for participants and trainers by invoking the appropriate agents, and selecting the update option in step 1908. The UpdateSeller is the agent used to change the participant information. The agent takes a new participant number entered in the DSSRec form, locates the data for that individual, and then updates the relationship within the DSSRec document between the service request and the participant. The change is not made to the database, however, until the user saves the updated service request using the SRUpdatelnfo agent.

Similarly, the UpdateTrainer is the agent used to change the trainer information. The agent takes a new trainer number entered in the DSSRec form, locates the data for that individual, and then updates the relationship within the DSSRec document between the service request and the trainer. The change is not made to the database, however, until the user saves the updated service request using the SRUpdatelnfo agent.

In steps 1909-1911, a user can elect to create a survey related to the training received. The OpenSurvey agent is the agent used to create and save a new survey. For example, if a service request is closed, and no survey is previously entered for it, the user may opt to fill out a new survey from the DSSRec form. That option creates and opens an SRSurvey form document. The SRSurvey form is used for the survey of a closed service request. The OpenSurvey agent creates a document using that form. The form solicits feedback from the user regarding the quality of the service received. The SendSurvey agent is used to save a service request survey document in the database. After validating user access, that agent saves the survey document in the database table as a new record, and then reloads the document containing the service request that is the subject of the survey.

In steps 1912-1913, a user can also elect to enter a new service request record in the database by invoking a NewSR agent. For example, if the user has the ability to “Edit/Add service requests, they can invoke a menu option that runs the agent. The agent creates a blank SRRec form, and opens it so that the user can create a new service request. When displayed, the user is prompted to enter the details of the service request.

FIG. 20 is flow diagram that illustrates the relationship between service request database tables in accordance with an embodiment of the present invention. In FIG. 20, the primary tables used for the service request feature of the certification program are S_SRV_REQ 2002 and S_CUST_SURVEY 2003. Table S_SRV_REQ 2002 is the table used to store detailed information regarding service requests, and S_CUST_SURVEY 2003 is the table used to store survey information related to training received. FIG. 20 also includes other tables that are not necessarily considered part of the service request feature, but are included to illustrate the overall context of the database tables used by the certification program. Table S_ORG_EXT 906 provides contact and account information that is used by the service request feature. Similarly, tables S_CONTACT 911, and CX_PARTICIPANT 2003 provide the necessary participant and trainer information to the service request feature.

The service requests feature is available to all subscribers who minimally have “Read “access privileges to the service request feature of the certification program. Depending on access rights, the user may have fewer or more privileges to manipulate service request information. Access is provided directly via the main menu option, or indirectly through links on screens for other types of records that have some sort of relationship to service requests.

The interface for searching the service request information is similar to the interface for all features of the certification program. All search criteria fields are case-insensitive-meaning that case is ignored when searching for matching terms, and the letters of words can be entered in either upper or lower case. All searches that involve text (names, addresses, etc.) are “wildcarded,” meaning that if the user enters a partial string, any records having a field that contains that string will be returned in the results. However, identifying numbers are not wildcarded. For example, a user cannot enter a partial phone, permit, or site number. A participant ID number is the unique number that is assigned to each participant using the certification program.

When a search is executed, a result screen is created based on the criteria (or lack thereof). That screen is fairly minimal, displaying some summary information regarding the service request. When there are more than 15-20 service requests found, the results are organized by “page” and there is a series of navigational controls at the bottom of the page that allow the user to go through the results. The paging mechanism for this search is the same as with all the searches in the system, as described elsewhere. The results can be sorted in alphabetic, ascending or descending order. The Individual sections and the content therein, may be adjusted, displayed or not depending on the access rights of the user.

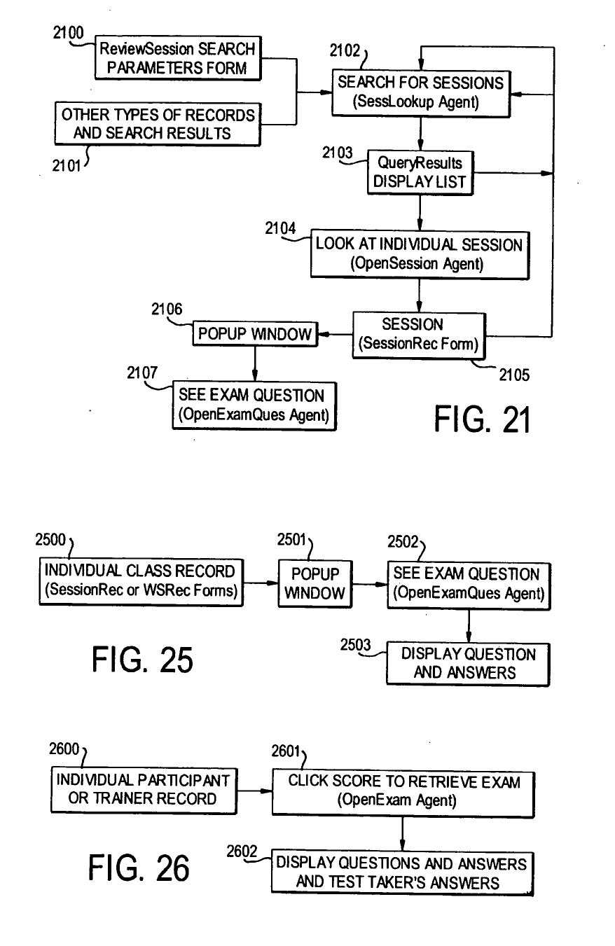

FIG. 21 is a flow diagram that illustrates the session feature of the certification program in accordance with an embodiment of the present invention. In FIG. 21, session information is retrieved through the SessLookup agent, which is either invoked through the search form ReviewSession in step 2100, or by “drilling down” from other related records in step 2101. The ReviewSession form is the point of entry for most users of the sessions feature. That feature presents a search screen for users and invites them to enter search criteria. After the user enters values in the various fields, and selects a search button, the SessLookup agent is called in step 2102.

The SessLookup agent retrieves a list of session records based on a session query by a user. The agent is the primary search agent used for retrieving session information. As stated previously, the agent is designed to be invoked either from the ReviewSession form (whereupon it searches the calling form for its parameters), or from two different sets of URL parameters. Similar to the other features of the certification program, in step 2103, the search results are directed to a QueryResults document, which caches a list of records found, and stores additional information that allows the user to refine the search results. If the user wishes to refine the search, the QueryResults document is updated and redisplayed.

In step 2104, the user can view an individual session using the OpenSession agent. The OpenSession agent retrieves an individual session record, and compiles a statistical summary of the session, which it then writes into a new document using the SessionRec form in step 2105. The session record can include information related to exams as well as evaluations related to a particular session. The SessionRec form is used for viewing an individual session. The form is always created using an existing record, and is populated with the current information regarding that session. The form also provides links to related information when applicable. In steps 2106-2107, the user can request to view the details of a particular exam. For example, if a user is viewing general exam information, he or she can also view the individual test questions. The user simply clicks on the exam causing a popup window to open. An agent is then run that retrieves the exam questions and displays them in the popup window to the user.

FIG. 22 is a flow diagram illustrating the relationship between session databases tables in accordance with an embodiment of the present invention. In FIG. 22, the primary tables used for implementing the session feature are S_CRSE 1801, CX_SESS_PART_X 1802, CX_SESSIONS_X 1806 and CX_SESS_TRNR_X 1807. Table S_CRSE 1801 is the table used to contain information related to the course of study taught in a particular session, and CX_SESS_PART_X 1802 is the table used to provide information regarding the participants of a particular session. Table CX_SESSIONS_X 1806 is the primary table used to store detailed information for the sessions offered in the certification program. Table CX_SESS_TRNR_X 1807 is the table that contains information regarding the individuals or trainers that teach the sessions offered by the certification program.

FIG. 22 also includes other tables that are not necessarily part of the session feature, but are included to illustrate the overall context of the database tables used by the certification program. For example, table CX_PARTICIPANT_X 1802 provides general participant information used by the session feature. Similarly, tables S_CONTACT 911 provide the general trainer information to the service request feature. The session feature also receives information from table CX_PART_TRNR_X 1807 regarding who trained a particular participant in a training session.

Similar to the other features of the certification program discussed thus far, the sessions feature is available to all subscribers who have at least “Read” access privileges to the session feature. The feature can provide detailed access to session related information within the context of other information. Additionally, users can directly search for sessions via the main menu option for a training session. Selecting the option from the main menu gives the user a search screen similar to other features of the certification program.

When a search is initiated, a result screen is created based on the criteria entered in the search screen (or lack thereof). The results screen that is produced has more or fewer links to related information in the certification program depending on the users' access rights. For example, if a user has access to account information, they may “drill down” to a desired account record of the participant in the search results lists. Otherwise the information is displayed, but no links are created.

FIG. 23 is a flow diagram that illustrates the trainers feature of the certification program in accordance with an embodiment of the present invention. In FIG. 23, trainer information is retrieved through the TLookup agent, which is either invoked from a search form ReviewTrainer in step 2300, or by “drilling down” through other related records in step 2301. The ReviewTrainer form is the point of entry for most users of the trainers feature of the certification program. A search screen is presented to a user and invites them to enter search criteria. After the user enters values in the various fields, and selects one of two search buttons, the TLookup agent is called in step 2302.

The TLookup agent is the primary search agent used for retrieving trainer information in the program. It is design to be invoked either from the ReviewTrainer form or from two different sets of URL parameters. The agent creates a QueryResults document of the trainers information found. As with other features of the certification program, the user is able to refine the search. The search result can be viewed using a TrainerRec form in step 2303. When a single form is found, the agent automatically opens the TrainerRec form containing detailed information regarding the record found.

The TrainerRec form is the primary form used for viewing an individual trainer. This form is always created using an existing record, and is populated with the current information regarding that trainer. The form also provides links to related information when applicable (and assuming the user has relevant access).

In steps 2304-2305, the user can change a trainer record. If edited, the trainer record is reloaded in the “edit mode,” and the record is updated and saved via the TUdateInfo agent in step 2306. The TUpdateInfo agent is a general agent for updating an existing trainer record. When invoked, the agent first ensures that the user has the appropriate access rights to change trainer information. Next, the agent validates the data entered in various fields to ensure that it is complete and in the correct format. Based on the form-type as well as the action specified, the agent can either create new records or update existing records in the database.

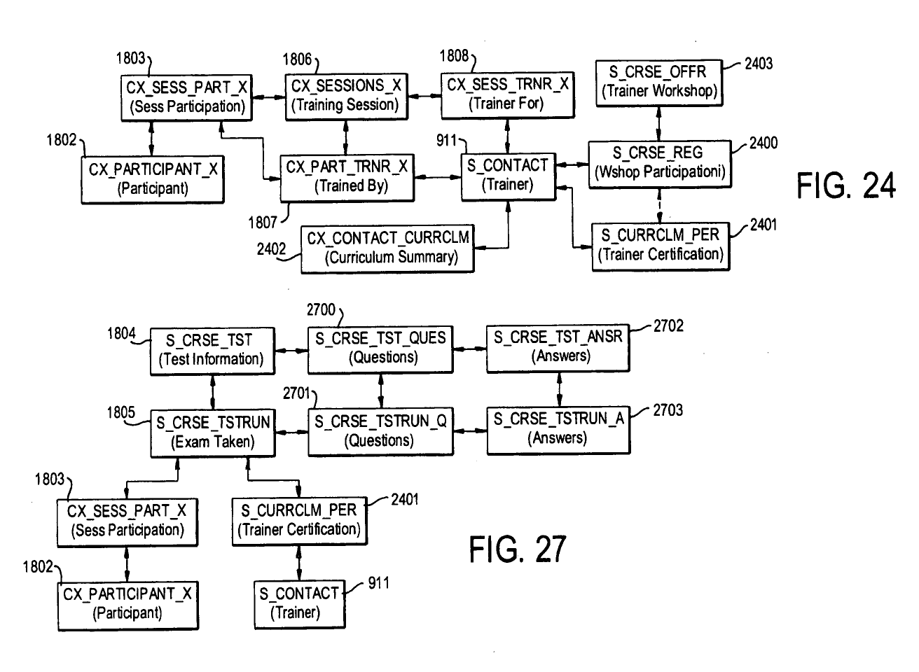

FIG. 24 is a flow diagram illustrating the relationship between trainer databases in accordance with an embodiment of the present invention. In FIG. 24, the primary tables for implementing the trainer feature of the certification program are S_CONTACT 911 S_CURRCLM_PER 2401, and CX_CONTACT_CURRCLM 2402. S_CONTACT 911, is the principle table used to store detailed information regarding the trainer. That table is also used to store contact records. The major distinction between trainer and contact records is the type of information and associations displayed. Trainer records are assumed to have both trainer and certification data, contacts records are not. However, updating a trainer's telephone number also updates the related contact record telephone number. Table CX_CONTACT_CURRCLM 2402, contains summary information related to each trainer's certification, and table S_CURRCLM_PER 2401 contains detailed information regarding a certification that was granted.

As seen in FIG. 24, there are other tables that are not necessarily part of the trainer feature, but are included in this diagram to illustrate the overall context of the database tables used by the certification program. For example, tables CX_SESS_PART_X 1803, CX_SESSIONS_X 1806, and CX_SESS_TRNR_X 1808 provide the session information to the trainer feature. Tables CX_PARTICIPANT_X 1802 and CX_PART_TRNR_X 1807 provide trainer and participant information to the trainer feature. Finally, tables S_CRSE_REG 2400 and S_CRSE_OFFR 2403 provide information to the trainer feature regarding workshop information. Those tables are the primary tables for implementation of the workshop feature, which will be discussed in more detail in the description of the figures that follow.

The trainers feature is available to all subscribers who have at least “Read” access to the trainer feature of the certification program. A query using the trainer feature provides detailed access to trainer related information. Similar to other features of the certification program, the trainer feature is accessed from the main menu or through a link within the context of other information. By providing relevant access to trainers from other types of records, and vice versa, the users are able to easily navigate these associations. If the user has “Edit/Add rights,” they have the option, while viewing an individual record, to edit it. That is invoked by clicking on the “Make Changes” button that is at the bottom of the screen presented to the user.

FIG. 25 is a flow diagram that illustrates the exam feature of the certification program in accordance with an embodiment of the present invention. In FIG. 25, a user retrieves a session or workshop record in steps 2500-2501 using the WSRec form. In step 2502, the user can retrieve the full-text of a question by selecting a question using the OpenExamQues agent. The agent is used to retrieve an exam question and answers, and is called from an exam summary prepared as part of the session summary. In step 2503, when an exam question or answer is selected by a user, it is displayed in a popup window presented to the user.

FIG. 26 is a flow diagram that illustrates the exam feature of the certification program in accordance with another embodiment of the present invention. In FIG. 26, a user retrieves a trainer or participant record in step 2600. The record also includes the certification history. If an exam is available, the score will be a link to the related exam. In step 2601, if the user selects the score, an OpenExam agent executes. The OpenExam agent is used to generate an exam and is typically called from an individual trainer or participant record. After verifying that the user has “Read” access to exams, and using parameters passed to it when invoked, the agent retrieves the specified certification exam record. The agent then generates a screen listing all of the questions and answers for the exam in step 2602. Questions that the exam taker answered incorrectly are so noted. The user cannot modify the screen or information in it. A link is also provided to allow the user to return to the previous certification record.

FIG. 27 is a flow diagram that illustrates the relationship of exam database tables used by the certification program in accordance with an embodiment of the present invention. In FIG. 27, the primary tables used to implement the exam feature are S_CRSE_TST 1804, S_CRSE_TST_QUES 2700, S_CRSE_TST_ANSR 2702, S_CRSE_TSTRUN 1805, S_CRSE_TSTRUN_Q 2701 and S_CRSE_TSTRUN_A 2703.

S_CRSE_TST 1804 is the principle table used to store an exam. S_CRSE_TST_QUES 2700 is the table used to store all of the questions associated with an exam. S_CRSE_TST_ANSR 2702 is the table used to store the answers to the questions associated with an exam. Table S_CRSE_TSTRUN 1805 is used to store general information regarding the exam taken by a trainer or participant. Table S_CRSE_TSTRUN_Q 2701 is used to store the questions related to the exam taken by a trainer or participant, and table S_CRSE_TSTRUN_A 2703 is used to store the answers to the questions related to an exam taken by a trainer or participant.

FIG. 27 also includes database tables that are not themselves considered the primary database tables used to implement the exam feature. Those tables are included in this diagram to illustrate the overall context of the database tables used by the certification program. For example, tables CX_PARTICIPANT_X 1802 and CX_SESS_PART_X 1803 provide participant and participant session information for implementing the exam feature. Similarly, tables S_CURRCLM_PER 2401 and S_CONTACT 911 provide trainer and trainer certification information to the exam feature.

The exams feature is available to all subscribers who have at least “Read” access privileges to the feature. There are two types of exam information presented to the user by the exam feature. For example, the display of an entire exam taken by an individual, which is provided through a link from the user's certification document, and the text of a single question, of which a link is provided from a class summary of the exam. If a question is answered incorrectly, the answer will be in indicated as such. For example, the incorrect question can be highlighted in red. The screen presented also includes, at the top of the exam summary, information related to the exam, the exam taken and the like.

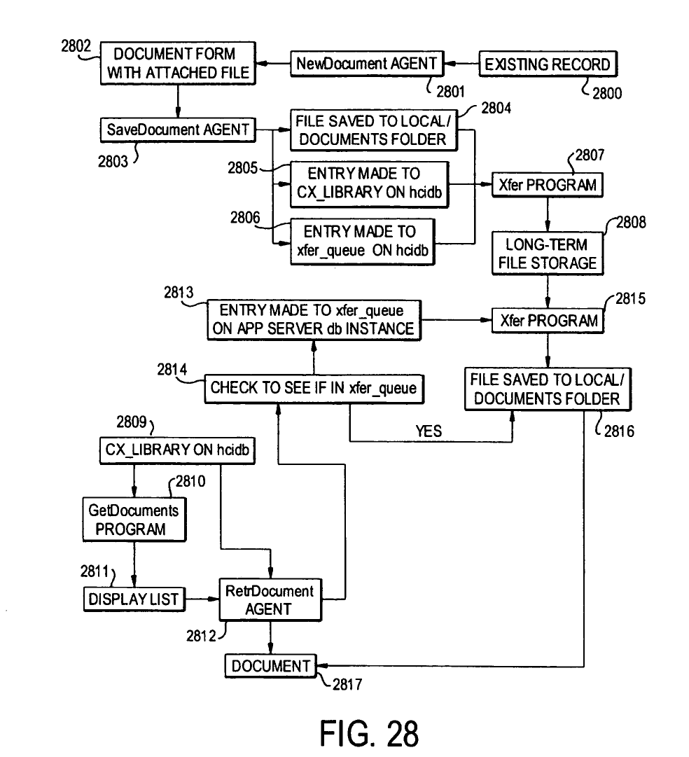

FIG. 28 is a flow diagram that illustrates the document management feature of the certification program in accordance with an embodiment of the present invention. In FIG. 28, while viewing a trainer, contact, participant or other record in step 2800, a user creates a new document or record by invoking a NewDocument agent in step 2801. The NewDocument agent determines the relationship that is being created with the document to an existing site/property, contact or other record, and then opens a blank document form. The document form is the primary form used for editing or adding a document to the system. When a new record is created, this form is invoked in a blank state. When a record is being edited, this form is populated with the current information regarding that document.

In steps 2802-2803, the user invokes a SaveDocument agent, which saves the context of the document and generates the document form. The SaveDocument agent stores the document locally in a temporary area, and makes the appropriate database entries to save the document in steps 2804-2806. The agent then queues a transfer program and returns the user back to the original record. The transfer program is an external service that is located on the application server. The communication between the application and this service is done entirely through the use of a queue defined in a commonly accessed database. The program functions defined above control the movement of files between the application server and the file server.

In steps 2807-2808, the transfer program transfers the document to long-term storage and deletes the document from the temporary storage area. When the form is saved (as a new document in the system) a relationship will be stored along with it. The relationship is specified as a parameter in the URL used to call this agent. However, if called from a standard GetDocuments search results screen, no relationship is created except to the subscription.

In steps 2809-2810, the GetDocument agent is invoked to list all the relevant documents from the CX_LIBRARY table, which is then displayed on step 2811. The GetDocuments agent is used for retrieving documents in the document management feature. The agent is designed to be invoked either from a form (whereupon it searches the calling form for its parameters), or from two different sets of URL parameters. It is invoked using URL parameters either from other forms, or as links embedded in the results screens generated by other agents.

In step 2812, the user clicks on a document, which opens a new window and executes the RetrDocument agent. The RetrDocument agent performs the core process of retrieving a document from a storage device, and sending it to a window in the web browser. In steps 2813-2815, the agent checks to see it the document is cached and opens the document in the same window. If the document is not cached, the agent queues the retrieval of the document to the transfer program based on the information in the CX_LIBRARY database table. In steps 2816-2817, if the document is cached, the agent monitors the queue, and when the document is retrieved, locally opens the document in the same window.

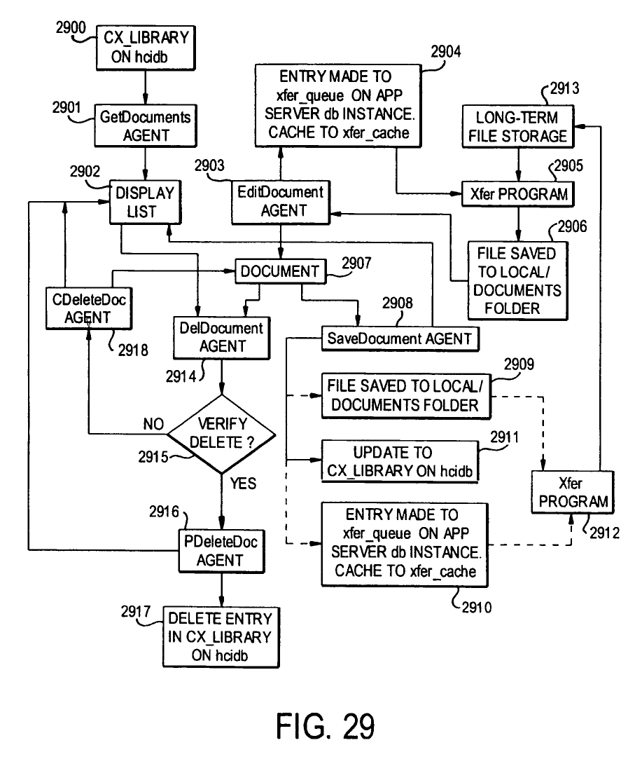

FIG. 29 is a flow diagram that illustrates the document management feature of the certification program in accordance with an embodiment of the present invention. In steps 2900-2901, the user retrieves a list of documents using the GetDocument agent and the list is displayed. The display has two links—one for edit and one for viewing. In steps 2904-2906, if the user decides to edit the document, the document is changed, saved at least temporarily and the user is returned to the same location. In step 2907, the file is opened for the user so that the user can then either update or delete the document.

In steps 2908-2913, if the user decides to update the document, the process is identical to the processing of a new document as described in connection with FIG. 28. Briefly, the SaveDocument agent saves the context of the document and generates the document form. The SaveDocument agent stores the document locally in a temporary area, and makes the appropriate database entries to save the document. The agent then queues a transfer program and the transfer program transfers the document to long-term storage and deletes the document from the temporary storage area. When the form is saved (as a new document in the system) a relationship will be stored along with it.

In steps 2914-2917, the user decides instead to delete the document by invoking the DelDocument agent. The DelDocument agent is invoked from either a list of documents, or from a document itself. When invoked, the agent also determines where the user will be placed at the completion of the deletion process, and validates that the user has the appropriate access privilege. The context information, along with basic information about the document being deleted, is placed in a DeleteDoc form and presented to the user to confirm the deletion. The DeleteDoc is the form used to confirm with the user that the document should indeed be deleted from the system.

When the document is deleted, the entry in CX_LIBRARY is removed, and a delete job is scheduled with the transfer program. The user can verify the deletion using the PDelete agent. The PdeleteDoc agent retrieves the information it needs from the DeleteDoc form that invoked it, and removes the related database records. Because the document could be in use by others when that is being done, the physical file associated with the document is not immediately removed from the system. After deleting the database references, the next location (also determined from the DeleteDoc form) is loaded. The CDeleteDoc agent determines the next location in the application where the user should be returned, and loads that location. The GetDocument agent is then reinvoked to assure that the list is up-to-date.

FIG. 30 is a flow diagram that illustrates the relationship between document management database tables used by the certification program in accordance with an embodiment of the present invention. In FIG. 30, the primary database tables used to implement the document management features are CX_LIBRARY 3000, CX_LIB_CATS 3001 and CX_LIB_CATEGORY 3002. CX_LIBRARY 3000 is the principal table in the data management feature. The table 3000 contains detailed information regarding each document that is stored and used for listing and searching documents. Table CX_LIB_CATS 3001 is the table used to store the categories specific to a subscription that are assigned to the documents or records within that subscription. Table CX_LIB_CATEGORY 3002 is used to store the assignment of categories to documents within a subscription. In other words, the table 3002 contains information related to the intersection of tables CX_LIBRARY 3000 and CX_LIB_CATS 3001.

The document management feature is available to all subscribers who minimally have “Read” access privileges to the certification program. The general purpose of this feature is for relating documents to other types of documents within the certification program. The result is a simple to use system that abstracts the storage of files so that the application can be running on multiple computers, and files are transparently moved back and forth between the web application servers and the file storage without human intervention. Using the document management feature of the certification program will result in a list of categories generated dynamically every time the screen is accessed. Basically, a query is executed that finds all of the unique categories associated with documents in the user's subscription. The user selects a single category from a drop-down menu. A partial name or title of the document can be entered in either upper or lower case. Words or phrases used in the document description (which can be up to 2000 characters long) can be entered in either upper or lower case. The search mechanism uses all of the criteria entered in its search.

When a search is initiated, a result screen is created based on the criteria (or lack thereof). The screen varies depending on whether the search was restricted to a category or not. If so, then the category column is omitted from the results, and the name of the category is included in the title of the screen. On all search results screens, the user will see both the title, and the description of the document that was entered when the document was added to the system. The document itself can be viewed by clicking on the name (or title). When that is done, a new window is opened, the document is retrieved from the storage to the web server where the request was initiated, and then sent to the user in that window.

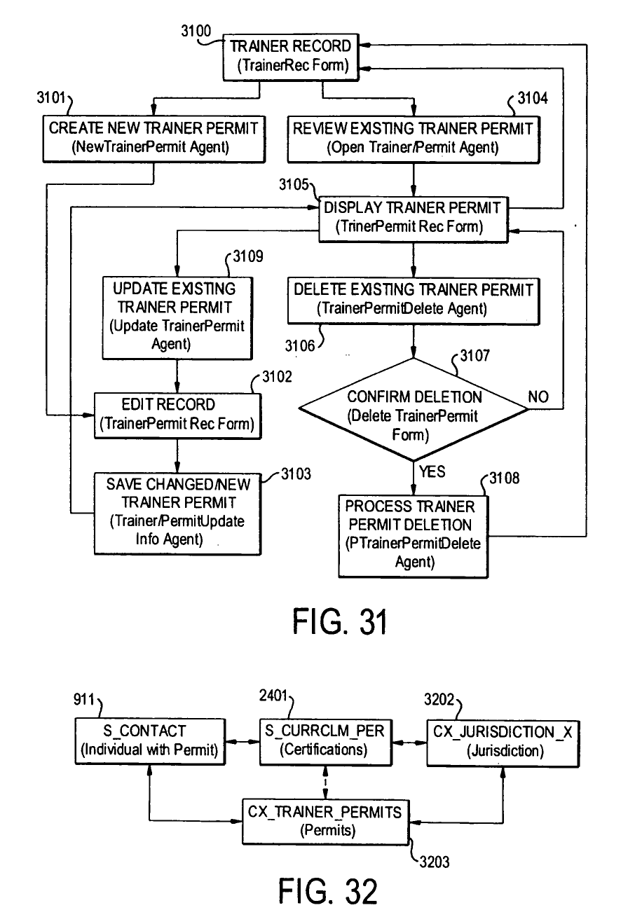

FIG. 31 is a flow diagram illustrating in more detail the trainer permit feature of the certification program in accordance with an embodiment of the present invention. The trainer permit feature allows a user to obtain information regarding a permit granted to a trainer. A trainer permit is the documented right to provide educational services through the receipt of a license by a regulatory body. In FIG. 31, if a user has the appropriate access rights, then they can view a trainer permit record in step 3100 in the TrainerRec from. From the form, a user can then either decide to create a new permit record or review in more detail the existing record. In step 3101, the user decides to create a new record by invoking the NewTrainerPermit agent. The NewTrainerPermit agent is invoked by making the appropriate selection in the displayed form. When called, the agent uses the newly entered parameters to generate a new trainer permit record for the user. The agent retrieves default values from applicable certification and jurisdictions, which it uses to populate pick lists. In generating the new record, the agent embeds the pick lists in the form as well as keys to relate the new record to a trainer.

In step 3102, the user can then edit the newly created record. The TrainerPermitRec form is populated with the existing information from that permit and is displayed for viewing. In step 3103, the user edits the form and saves the changes by invoking the TrainerPermitUpdateInfo agent. The agent is invoked from the TrainerPermitRec form and allows the user to save a new or changed record to a database. The agent inserts the information, updates the applicable display within the associated trainer record and then reloads the form that was being edited when the agent was invoked. The agent also generates a confirmation message to acknowledge that the update operation is complete.

In the alternative, in steps 3104-3105, the user can chose to review and display the existing record by invoking the OpenTrainerPermit agent. The OpenTrainerPermit agent is invoked from a list of trainer permit records by selecting the permit number for a corresponding permit. When called, the agent receives the ID of the permit record, which is then retrieved from the database and the record information is used to populate the TrainerPermitRec form. The form is displayed in a non-editing mode and the user must have the access privileges to edit permit records. If a user decides to then delete the form, then in step 3106 the user invokes the TrainerPermitDelete agent, which creates a Delete TrainerPermit form to confirm a deletion of the record. The TrainerPermitDelete agent is invoked from the TrainerPermitRec form, and, based on information in that form, generates a confirmation screen in the DeleteTrainerPermit form in step 3107. The ID of the permit to be deleted is also embedded in that form to allow subsequent processing. In step 3108, if the user confirms deletion, the PTrainerPermitDelete agent is invoked to process the deletion, update the displayed permit record and return the user to that record.

In step 3109, a user when viewing an existing record, as in step 3105, can decide to edit a record by invoking the UpdateTrainerPermit agent. The UpdateTrainerPermit agent is invoked by selecting the “make changes” button in the record. The agent reloads the TrainerPermitRec form in the exit mode so that changes can be made to the record.

FIG. 32 is a flow diagram illustrating the relationship between trainer permit database tables used by the certification program in accordance with an embodiment of the present invention. The primary database tables for implementing the trainer permit feature are CX_Trainer_Permits 3203 and CX_JURISDICITON_X 3202. Table CX_Trainer_Permits 3203 is used to store general information regarding a permit. The table does not hold any detailed information regarding a permit except for a permit number and expiration date. The database also includes references to tables that store contact and certification information as well as references to a jurisdiction table. Table CX_JURISDICITON_X 3202 contains information regarding regulatory jurisdictions, and has references to tables that hold designated addresses, contacts and account information for particular jurisdictions. FIG. 32 also includes other tables that are not necessarily part of the trainer permit feature, but are included to illustrate the overall context of the database tables. For example, table S_CONTACT 911 provides the general trainer information to the trainer permit feature and S_CURRCLM_PER 2401 provides certification information to the trainer permit feature.

The trainer permit feature is available to subscribers who minimally have “Read” access privileges to the trainer permit feature. Depending on the access rights, a user may have more or fewer privileges to manipulate permit information. If a user does not have the required access rights, then there will be no options or links presented to the user for the trainer permit feature. A trainer permit record is accessed generally from a trainer related record. To that end, the trainer permit feature can provide detailed information related to trainer permits, within the context of other trainer information being viewed by the user.

When a user is viewing a training record, there are respective options presented along with the information that allows the user to edit or delete a training permit record. The editing/add screen provides fields to specify the permit number or code, the expiration date, the jurisdiction and certification related to the trainer permit. The user is also presented with an option for saving changes to trainer permit records. After the changes are saved, a message is presented that confirms the update or addition of the record. Similar to the edit options, the user is also presented with corresponding delete options for removing a trainer permit record. The user is required to confirm a deletion prior to the removal of a record for a program database.

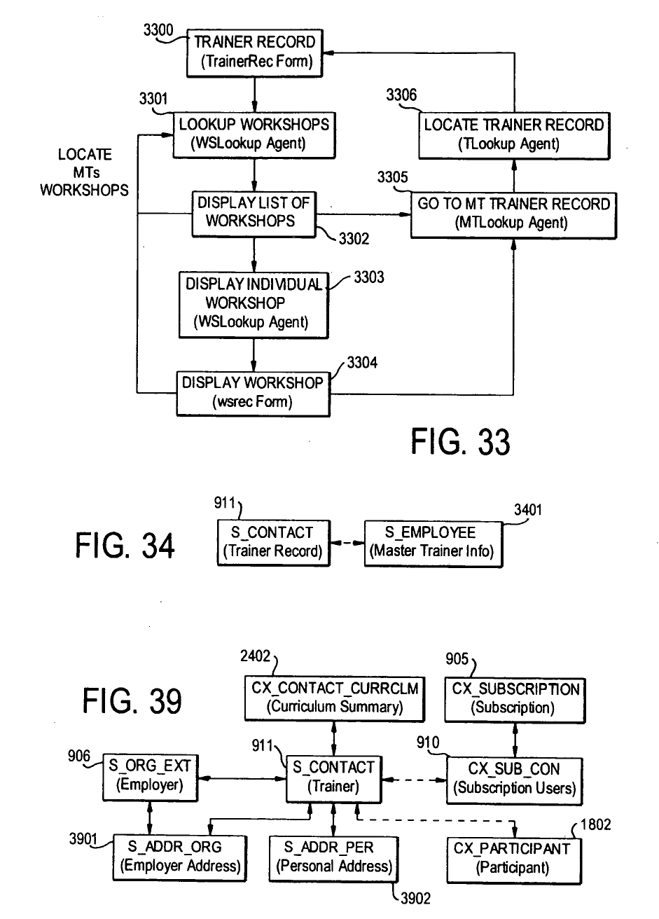

FIG. 33 is a flow diagram that illustrates the master trainer feature of the certification program in accordance with an embodiment of the present invention. In FIG. 33, if a user has the appropriate access rights, they can view master trainer information in step 3300. The master trainer record is viewed in a TrainerRec form and can be accessed from either a workshop record or trainer record. The master trainer feature provides a way for a user to locate and display trainer and workshop information. When viewing a master trainer record, a user can search for a workshop conducted by a particular master trainer by invoking a WSLookup agent in steps 3301-3302. In step 3303, from a list of workshops, the user selects a master trainer number to see a list of workshops trained by that individual trainer, which invokes a WSLookup agent.

In the alternative, for the workshop list, the user can select the name of the master trainer to invoke an agent that will locate the applicable trainer ID and then call a lookup agent to locate the relevant trainer information. The user must have at least “Read” access privileges in order to execute the MTLookup agent, which the WSLookup agent validates. In steps 3305-3306, from a workshop record, the user selects a master trainer number to see the list of workshops trained by a particular master trainer. As before, the user can also select a name of a master trainer to locate the relevant trainer information.

FIG. 34 is a flow diagram illustrating the master trainer database tables used by the certification program in accordance with an embodiment of the present invention. The primary tables used for implementing the master trainer feature are S_EMPLOYEE 3401 and S_CONTACT 911. Table S_EMPLOYEE 3401 is used to store general master trainer information. A master trainer is simply a trainer that has a few additional attributes. These attributes are stored in the table S_EMPLOYEE 3401, which is also an extension of table S_CONTACT 911. Master trainer information is implicitly related to the trainer record of an individual. For example, one cannot be a master trainer unless they are also a trainer. Within table S_CONTACT 911 there are two fields. One field indicates if an individual is a master trainer and the other field provides a key to the attributes of the master trainer. As indicated before, a trainer may be a master trainer, but a master trainer must also be a trainer.

The master trainer feature is available to all subscribers or users that minimally have “Read” access privileges to the master trainer feature. It is contemplated by the invention that “Read” access privileges will be the only privileges available with regard to the master trainer feature. Master trainer information is accessed from a trainer record. By way of example, when using the master trainer feature, the user is presented with trainer records of individuals identified as master trainers, or a list of workshops trained by an individual. More detailed information can be provided by selecting a trainer number or name.

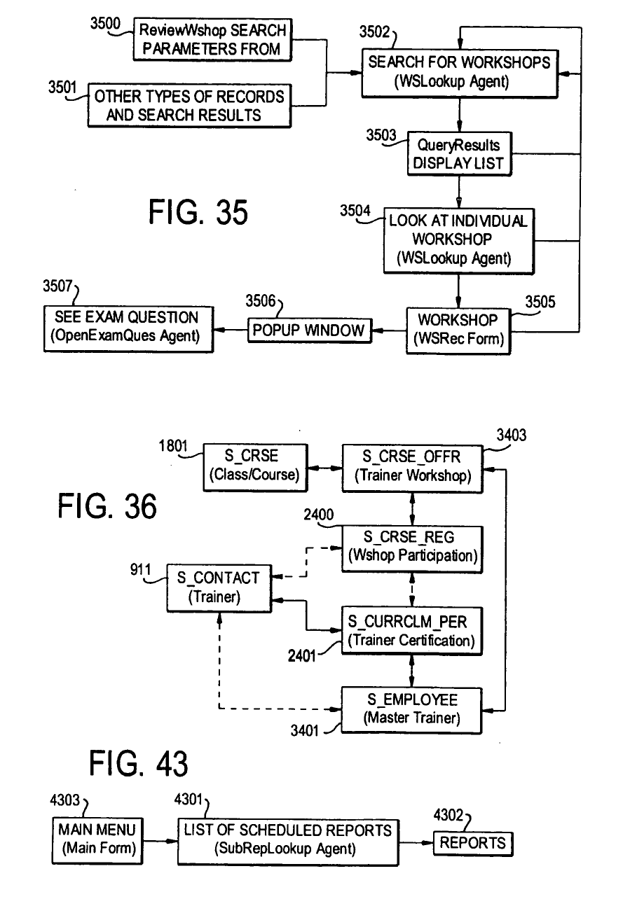

FIG. 35 is a flow diagram that illustrates the workshop feature of the certification program in accordance with an embodiment of the present invention. In FIG. 35, workshop information is retrieved through a WSLookup agent, which is either invoked from a search form in step 3500, or by a “drilling down” from other related records in step 3501. The WSLookup agent is the primary agent used for retrieving workshop information. It is designed to be invoked either from the ReviewWshop form, or from two different sets of URL parameters. It is invoked using URL parameters either from other forms, or from links embedded in the results screens generated by other agents.

In step 3502, the results of all searches are directed to a QueryResults document that caches a list of the first 1,000 records found matching the search criteria. The search results are displayed to the user in step 3503. Information is also included that allows a user to refine the search results. If the user chooses to refine the search results, the QueryResults document is updated and redisplayed.

In step 3504, if the user selects a workshop from a list of workshop information displayed, the WSLookup agent is reinvoked. The WSLookup agent retrieves all of the detailed information and generates a statistical abstract for the exams and trainers related to the workshop. That information is displayed in a document created with the WSRec form in step 3505. The WSRec form is the primary form used for viewing an individual workshop. This form is always created using an existing record and is populated with the current information regarding that workshop. The form also provides links to related information when applicable. The form contains logic that calculates access to information and format coding that organizes and arranges information. The form also contains a complete list of workshop participants as well as a summary of exam scores for each participant. In steps 3506-3507, a user can view the details of an individual question by selecting the question from the exam summary. An OpenExamQues agent then retrieves the details of the question and displays it in a popup window.

FIG. 36 is a flow diagram illustrating the workshop database tables used by the certification program in accordance with an embodiment of the present invention. The primary database tables used for implementing the workshop feature are S_CRSE_OFFER 2403, S_CRSE_REG 2400, and S_CRSE 1801. Table S_CRSE_OFFER 2403 is used for storing information regarding workshops. Table S_CRSE_REG 2400 is used to store information regarding registrants for a particular workshop. Table S_CRSE 1801 is used to store information regarding the courses being taught in a workshop.

FIG. 36 also includes other tables that are not necessarily part of the trainer permit feature, but are included to illustrate the overall context of the database tables used by the certification program. For example, table S_CONTACT 911, S_CURRCLM_PER 2401 and S_EMPLOYEE 3401. Tables S_CONTACT 911 and S_CURRCLM_PER 2401 provide the general trainer and trainer certification information to the workshop feature. Additionally, table S_CURRCLM_PER 2401 provides certification information to the workshop feature.

The workshop feature is available to all subscribers or users that minimally have “Read” access privileges to the master trainer feature. Depending on the access rights of a user, they may have more or less privileges to manipulate workshop information in the program. As with all the features of the program, access privileges are controlled by the rights management feature of the certification program. Workshop information can also be provided in the context of other information being viewed by the user. The relationship that workshop information has with other information is considered to be as important as the workshop information itself. By providing access to workshop information in the context of other information, the user is able to easily navigate through the program to obtain relevant certification information.

As mentioned previously, a user can gain access to the workshop information via a main menu option, or directly through links on screens related to other information being viewed by the user. As with other features, all search criteria fields are case-insensitive and all searches using text are “wildcarded.” However, identifying numbers are not wildcarded. When more than 10 workshops are found, the results are organized by “page” and there are a series of navigational controls at the bottom of each page that allow the user to go through the results. The paging mechanism for the workshop feature is the same for all searches in the program, and is described elsewhere. The results can be sorted by alphabetic, ascending or descending order. The information on a page is organized in sections and the content therein may be adjusted, or displayed depending on a user's access rights. The page also includes links for providing access to information in other related areas. The links are context driven meaning that they will locate information related to the document being viewed. For example, selecting a link related to account information would retrieve account information related to the record being viewed.

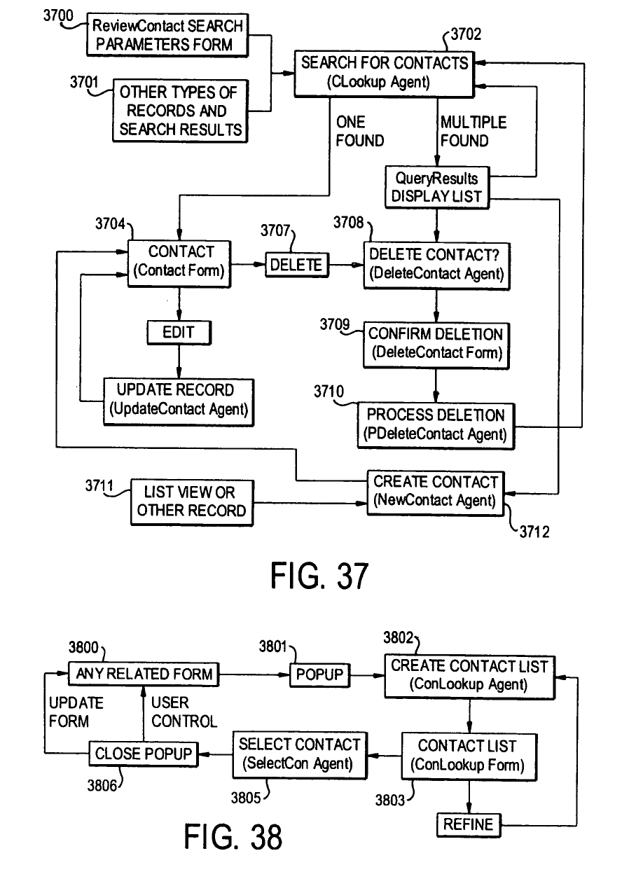

FIG. 37 is a flow diagram that illustrates the contact feature of the certification program in accordance with an embodiment of the present invention. In FIG. 37, contact information is retrieved through the CLookup agent, which is either invoked from the search form in step 3700, or by “drilling down” from other related records in step 3701. The CLookup agent is the primary agent used for retrieving contact information from the program. Access to contact records can also be obtained through the user interacting with an existing contact record. Contact records are the basic entity that is used to store attributes regarding individuals.

In step 3702, if the search produces multiple records, the agent creates a QueryResult document caching a list of the first 1,000 records found that match the search criteria. The results also include information that allows the user to refine the search results. If the user refines the search, the results of the QueryResults document is updated and redisplayed. On the other hand, in step 3704, if the CLookup agent finds only a single record, it will automatically locate detailed information, and compose and open a contact form containing relevant information about the contact record.

When a record is displayed, it becomes the point where a record can be either edited or deleted. In steps 3705-3706, the user edits the record. When selected, the record form is reloaded in the “edit mode,” and the user can select alternative address and site records using popup applets. From there, the information can be updated by invoking the UpdateContact agent and saving the changes. The UpdateContact agent is the general agent for adding a new contact record or updating an existing contact record. When invoked, the agent first looks at the form that called it and then determines if the user has the appropriate access rights. Next, it validates the data entered to ensure that it is complete and in the correct format.

In steps 3707-3710, the user decides, instead, to delete the contact record by invoking the DeleteContact agent. The DeleteContact agent is invoked from the contact record itself, or from a contact search results screen generated from the CLookup agent. If the user deletes the contact record, the record is removed, a confirmation is sent and the user is returned to the point where they were before the contact record was entered by the PDeleteContact agent. If the user has the appropriate access rights, they can also create a new contact record. In steps 3711-3712, the user selects the appropriate menu option to create a contact record, which invokes a NewContact agent. The agent creates a form, which is handled the same as when a record is updated, as discussed above.

FIG. 38 is a flow diagram that illustrates the contact feature of the certification program in accordance with an embodiment of the present invention. In FIG. 38, if a user has access rights, then they can change the association between a record and an account. In step 3800, a user is editing a record. When an edit selection is made, a popup window is opened, which runs a ConLookup agent in steps 3801-3802. The ConLookup agent retrieves a list of contact records and allows the user to make a selection. In step 3803, the ConLookup agent compiles a list of alternative contacts, and creates a ConLookup form that is loaded in a popup window. In step 3804, the user can refine the search, which updates the form and reloads it in the same window.

In step 3805-3806, the user selects a contact record from a list, which invokes a SelectCon agent. The SelectCon agent updates the form that was being edited when the process was initiated and closes the popup widow. The agent then causes the browser to reload the form with the new data. The new relationship is stored temporarily until the user saves the form.

FIG. 39 is a flow diagram illustrating the contact database tables used by the certification program in accordance with an embodiment of the present invention. The primary database tables used for implementing the contact feature include S_CONTACT 911, CX_SUB_CON 910 and S_ADDR_PER 3902. S_CONTACT 911 is the table used to store basic contact information. Access to subscription, trainer and participant information can be attributes of a contact record, and so the contact database tables also store basic user, trainer and participant information. All trainers and users and many participants have records in the contact database tables. A substantial portion of each contact record in the database tables includes foreign keys to other tables.

CX_SUB_CON 910 is the table used to store subscription information related to users of the certification program. If an individual is a subscription holder to the program, they will have a record in that table. S_ADDR_PER 3902 is the table used to store address information for an individual. Personal addresses are unrelated to corporate addresses, and an individual may have as many personal addresses as they need, but only one business or work address will be accepted.

FIG. 39 also includes other tables that are not necessarily part of the contact feature, but are included to illustrate the overall context of the database tables. For example, table S_ADDR_ORG 3901 provides employer information to the contact feature and S_CURRCLM_PER 2401 provides employer address information to the contact feature. Every employer record may have one or more contact records, but a contact record may be associated with only one account. Similarly, a contact record may only have one business or employer address record, but multiple personal addresses. Table CX_CONTACT_CURRCLM 2402 provides information regarding certification curriculum, table CX_SUBSCRIPTION 905 provides general subscription information, and table CX_PARTICIPANT_X 1802 provides general participant information. Contact records may be tracked based on a business unit ID, which allows the same organization to be entered multiple times if necessary. However, certain information may be kept partitioned so that viewing is restricted. Additionally, a contact may or may not have detailed records related to a user, a participant or a trainer.

The contact feature is available to all subscribers that minimally have “Read” access privileges to the contact feature of the certification program. The contact feature is a general-purpose mechanism for relating contact records to other types of records as well as providing access to the contact records using a general-purpose and specialized search mechanism. The contact information can be access within the context of other related information being viewed by a user. The relationship that contact information has with other related information in the certification program is as important as the contact information itself.

As mentioned previously, access to contact information can be via a main menu option, or directly through links related to other types of records that have some sort of relationship to a contact record. However, the most common way of accessing the contact information is by selecting a link on a results screen for other types of records, or by selecting a link on an individual record. As with other features, all search criteria fields are case-insensitive and all searches using text are “wildcarded.” However, identifying numbers are not wildcarded. When more than 20 contact records are found, the results are organized by “page” and there are a series of navigational controls at the bottom of each page that allows the user to go through the results. The paging mechanism for the contacts feature is the same as for all features of the program, and is described elsewhere. The results can be sorted by alphabetic, ascending or descending order. The information on a page is organized in sections and the content therein may be adjusted, or displayed depending on a user's access rights. The page also includes links for providing access to information in other related areas. The links are context driven meaning that they locate information related to the document being viewed.

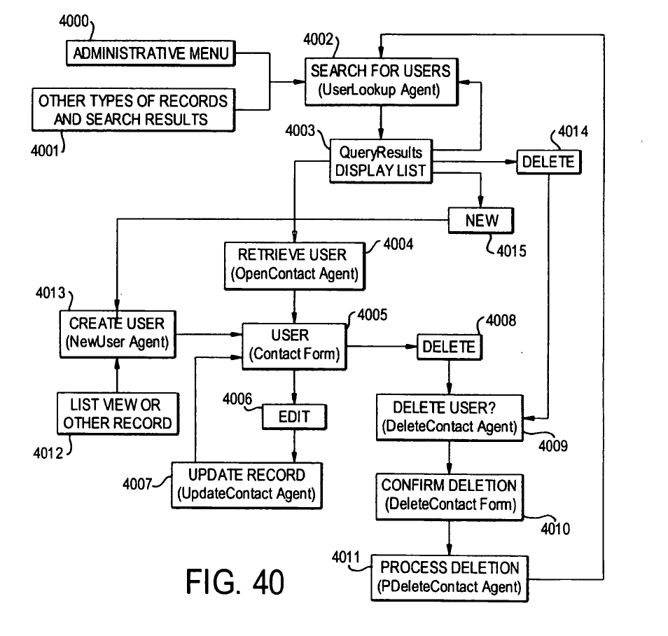

FIG. 40 is a flow diagram illustrating the supervisor feature of the certification program in accordance with an embodiment of the present invention. In FIG. 40, supervisor information is retrieved through a UserLookup agent, which is either invoked from a search form in step 4000, or by “drilling down” from other related records in step 4001. The LookUp agent is used to retrieve a list of current users of a subscription. In order for a user to be able to access the supervisor information, a user must have both a subscription supervisor flag as well as access privileges to supervisor information. Supervisor information can also be accessed through the user interacting with an existing list on a user record. In step 4002, if a search of supervisor information produces multiple results, the agent will create a QueryResult document caching a list of the first 1,000 records found that match the search criteria. The results are displayed to the user in step 4003. The results include information necessary to allow the user to refine the search results. If the user chooses to refine the search results, the QueryResults document is updated and redisplayed.

In step 4004, if a single record is found, the OpenContact agent will automatically locate the detailed information and present the detailed information to the user in a Contact form in step 4005. From this point, the user has the option to edit or delete the record. In step 4006, the user edits the record. The user can select alternative address and site records, define rights and access restrictions, and update contact and password information. When the changes are made, the UpdateContact agent in step 4007 makes the record updates immediately.

On the other hand, in steps 4008-4011, the user can elect to delete a record. The user deletes the record by invoking the DeleteContact agent. After the deletion is made and confirmed by the DeleteContact form, the record is removed and the user is returned to the point before they entered the supervisor record by the PDeleteContact agent. If a user has appropriate access rights, they can select a menu option to also create a new supervisor record or user record by invoking a NewUser agent, in steps 4012-4013. The agent creates a form document, which is handled the same as a supervisor or user record that is being updated, as already mentioned above. Additionally, in steps 4014-4015, a record can always be deleted or a new record created after the results of a query are presented to the user. The supervisor feature is composed of a series of database tables that have already been discussed. There are no unique data structures for implementing the supervisor feature. For example, the supervisor feature is implemented by using information in database tables CX_SUBSCRIPTION 905, CX_SUB_CON 910, SC_SUB_CON_PRIV 912, SC_SUB_MSG 909 and S_CONTACT 911, which were previously discussed in connection with the description for FIG. 9.

The supervisor feature is available to all subscribers having at least “Read” access privileges to the supervisor feature of the certification program. Depending on the access rights, a user may have more or fewer access rights to manipulate information in the certification program. The purpose of the supervisor feature is to provide a general-purpose mechanism for allowing users to administer subscription characteristics through a specialized menu, which is separate from the normal menu. The feature is accessible from an option called “Administration menu.” The option is located in the “Other” section of the main menu, which is generated based on the specific rights a user has to administer their subscription. If a user does not have a “Supervisor” flag checked on their subscription record, then the rights do not exist and access is denied.

It is contemplated by the invention that three major characteristics of a subscription may be directly administered using the supervisor feature: 1) the subscription message displayed on the main menu; 2) the logo that is displayed on many screens; and 3) a list of valid users and their rights to access information. Additional administrative privileges can also include options to administer other database features as well. A subscription message can be “scrolling” or “static.” The message can appear in the lower right hand side of the main menu for all users listed on a given subscription. A supervisor user can also specify the logo that appears on the main screen, and several locations elsewhere in the certification program. The supervisor has the ability to maintain the other users of a given subscription, as well as define new users up to the maximum number permitted under the subscription. That essentially empowers the users of a subscription to assume the duties of maintaining the subscription and as well as to resolve user access issues.

When more than 20 user records are found, the results are organized by “page” and there are a series of navigational controls at the bottom of each page that allow the user to go through the results. The paging mechanism for the supervisor feature is the same for all features in the program, and is described elsewhere. The results can be sorted by alphabetic, ascending or descending order. The information on a page is organized in sections and the content therein may be adjusted, or displayed depending on a user's access rights. The page also includes an option to add a new user to a subscription.

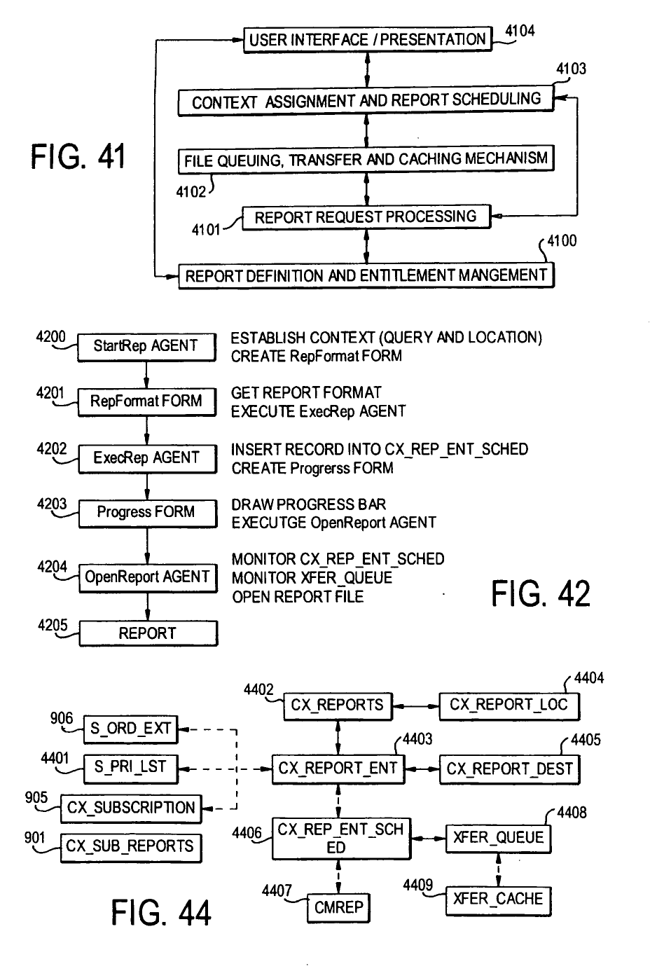

FIG. 41 is a flow diagram that illustrates an overview of the report feature of the certification program in accordance with an embodiment of the present invention. The primary components for implementing the report feature are the report definition and entitlement management component 4100; the report request processing component 4101; the file queuing, transfer and caching mechanism 4102; the context assignment and report scheduling component 4103; and the user interface/presentation component 4104.

The report definition and entitlement management component 4100 is the basic starting point of the system, and actually occurs entirely outside of the certification program. There are a series of data structures that define what a report is, how it can be delivered, who is entitled to receive it, and the format of the report itself. The report itself could be physically defined using, for example, a Crystal Report, which may be an application from another software company. The data structures in the component store references to the report, as well as what reports are allowed under a specific subscription. Based on the reports that are allowed under a subscription, and the report definitions, an agent is periodically executed that generates “entitlement” records that allow the user to see the report and “Output” rights to various functions. Additionally, there is another data structure that associates reports with given functions within the certification program.

The report request processing component 4101 is a stand-alone, independent process that monitors the report scheduling system. Based on a request for a report, the report processing component 4101 of the report feature generates and delivers the results to a specified location in a specified format. This system utilizes the Crystal Report to process the report format with the parameters given to it when the report was scheduled. Based on the delivery destination, the results are placed into an area where they can be picked up by the file queuing, transfer and caching mechanism 4102 of the report feature.

The file queuing, transfer and caching mechanism 4102 monitors a job queue, and based on information in the queue, transfers files (if necessary) to the specified destination. The transfer of a report is initiated from the report request processing component 4101, and monitored for completion by the context assignment and reporting scheduling component 4103 for ultimate delivery to the user interface/presentation component 4104.

The context assignment and report scheduling component 4103 is a set of routines for packaging together the information about a report being requested, the format specified, and the context of the report. The report is then presented as a queued report job with the context turned into report parameters. The component schedules a report to be executed by the report request processing component 4101, and then waits for the results to be provided to it by the file queuing, transfer and caching mechanism 4102.

The user interface/presentation component 4104 manages what reports a user sees, and the context in which a report is presented. The presentation of a report is managed by a set of specialized routines that are commonly invoked virtually everywhere in the application where a screen is generated for a user. Every screen that is generated is assigned an ID, which relates to the association table that ties a screen back to specific reports. If a user enters a screen that has a report assigned to it, and the user has access to reports on that screen, then the unique criteria used to generate that screen is stored. The user is then given the option of running one of the reports available on that screen. When the user initiates a report, the context assignment and reporting scheduling component 4103 is invoked, which when the report is completed, hands the results back to the user interface/presentation component 4104.

FIG. 42 is a flow diagram that illustrates the report feature of the certification program in accordance with an embodiment of the present invention. More specifically, FIG. 42 illustrates in more detail the user interface/presentation component, and context assignment and report scheduling components of the report feature. In step 4200, a StartRep agent is invoked to open a report. The StartRep agent is the agent used to initiate the search process, and generate a form to solicit the format for the report. In step 4201, the RepFormat agent is invoked to solicit from the user the format of the report. In step 4202, the ExecRep agent writes a record to a table in the report database to schedule the back-end execution of the report, and then creates and opens a progress form in step 4203. In steps 4204-4205, the OpenReport agent monitors the scheduled report queue to determine the transfer of the report and opens the report when transferred. The report is then presented to the user.

FIG. 43 is a flow diagram illustrating the report feature of the certification program in accordance with an embodiment of the present invention. More specifically, FIG. 43 illustrates in more detail the file queuing, transfer and caching mechanism of the report feature. The report feature of the certification program utilizes the file queuing, transfer and caching mechanism to transfer report records to the web application server. It does that by initially placing the report in the document management system, and then queuing a transfer of that file to the application server by writing a record to the appropriate XFERQUEUE table that serves the application server. In step 4300, the user is presented with the main menu and makes a selection for receiving a report. In step 4301, the SubRepLookup agent checks to see if any scheduled reports have been delivered to the certification program for the user requesting the report. In step 4302, once the report is delivered, the report is presented to the user by the user interface/presentation component of the report feature.

FIG. 44 is a flow diagram illustrating the report database tables used by the certification program in accordance with an embodiment of the present invention. The primary database tables used to implement the report feature include CX_REPORTS 4402, CX_REPORT_LOC 4404, CX_REPORT_ENT 4403, CX_REPORT_DEST 4405, CX_REP_ENT_SCHED 4406 and CX_SUB_REPORTS 901. CX_REPORTS 4402 is the table used to store the basic definition and description of a report in the certification program as well as a flags to delineate scheduled reports from ad-hoc reports. CX_REPORT_LOC 4404 is the table used to tie a report back to a given screen in the certification program. Each screen is assigned a unique ID, and the table associates those screens with reports. CX_REPORT_ENT 4403 is the table used to indicate that a given subscription is entitled to see a specific report. Those entitlement records are generated automatically by the agent from records in table CX_SUB_REPORTS 4402.

CX_REPORT_DEST 4405 is the table used to define the destination of a report. All ad-hoc reports utilize a predefined destination of a “portal,” which directs them to the document management feature and the file transfer queue component. CX_REP_ENT_SCHED 4406 is the table used to schedule a report for execution by the back-end report generation system. A record is created in the table to indicate what report to run, when to run the report, whether there are any fixed parameters, the format, and where to place the results. If an ad-hoc report is being generated the file created is also given a transfer ID to be used to queue the transfer of the report to the web application server. CX_SUB_REPORTS 901 is the table used to indicate which reports are available to a specific subscription.

FIG. 44 also includes other tables that are not necessarily part of the report feature, but are included to illustrate the overall context of the database tables. For example, S_ORG_EXT 906, S_PRI_LST 4401, CX_SUBSCRIPTION 905, CMREP 4407, XFER_QUEUE 4408 and XFER_CACHE 4409. Those tables are used to provide general information for implementation of the report feature of the certification program.

Report feature is provided implementation with other functions within the certification program to aggregate and analyze data stored in those features as well as for the purpose of generating and displaying a file containing that information. These are generated in an ad-hoc fashion based on user initiated requests within each individual feature of the certification program. Additionally, the reports feature is implemented as a store for scheduled and pre-computed reports, and a method for retrieving those reports for users. The reports feature mediates between a front-end mechanism for specifying and/or accessing reports, and a separate back-end infrastructure that processes report requests and delivers them to specified destinations, through a variety of mechanisms. Reports are available to users that have the “Output” access right on a given feature of the certification program, or have access to the reports feature with minimally “Read” access rights. The former is used to control access to ad-hoc reports, and the latter to schedule reports.

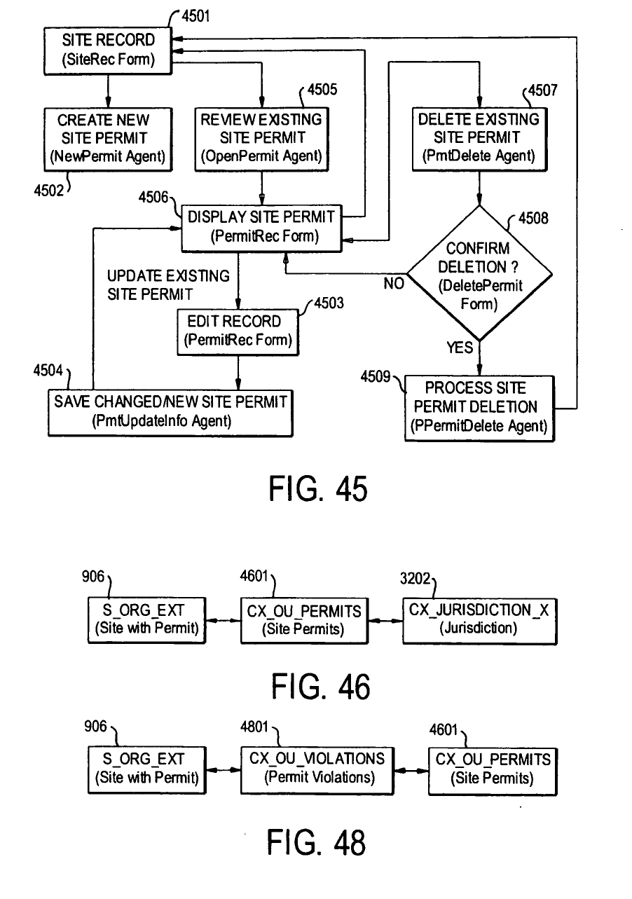

FIG. 45 is a flow diagram illustrating the site permit feature of the certification program in accordance with an embodiment of the present invention. In step 4501, the user has access rights to view a permit record in the SiteRec form. From there, the user can decide to create a new record or review the exiting record in more detail. In step 4502, the user creates a new record by invoking a PermitRec form. The PermitRec form is used by agents to display or allow changes to a new or existing permit record. The form contains embedded fields that store temporary values and keys. Those values and keys allow any agents invoked from that agent to navigate the user through the application properly and write data to the database.

The PermitRec form is populated with default values from the NewPermit agent and is displayed for editing in step 4503. The NewPermit agent is invoked from a site permits record and uses parameters passed to it to generate a new site permit record for the user. When generating a new form, the agent also retrieves default values for applicable certifications and jurisdictions, which it uses to populate pick lists. The agent generates a form that embeds those pick lists, as well as keys to relate the new permit back to a site

In step 4504, the user then saves the record by invoking the PmtUpdatelnfo agent, which updates the database, updates the site permit displayed in the record itself and returns the user to the site permit record form. On the other hand, in step 4505, the user views the exiting document by invoking the OpenPermit agent, which then displays the record in a PermitRec form in step 4505. The OpenPermit agent is invoked from a list of site permit records by selecting a permit number of a permit. When called, the agent is passed the ID of an existing permit record, which it retrieves from the database and populates into a PermitRec form, which it displays in a non-editing mode. The user must have the ability to edit permits in order to execute this agent.

When viewing an existing record, a user also has the option to edit the record. If the user edits an existing record, the PermitRec form is populated with existing information from that permit and is displayed for reviewing. In steps 4507-4509, a user can also decide to delete a record that is being displayed. A record is deleted by invoking a PmtDelete agent, which creates a DeletePermit form to confirm the deletion. If the user does not confirm the deletion, they are returned to the site permit record. If the deletion is confirmed, the PPermitDelete agent is invoked, which processes the deletion, updates the displayed permit, and returns the user to that record.

FIG. 46 is a flow diagram illustrating the site permit database tables used by the certification program in accordance with an embodiment of the present invention. The primary database tables used for implementing the site permit feature are CX_OU_PERMITS 4601 and CX_JURISDICTION_X 3202. CX_OU_PERMITS 4601 is used to store information regarding permits and the jurisdiction in which the permits were granted. Site permits, by definition, are granted for use by a single site. CX_JURISDICTION_X 3202 is the table used to store information regarding regulatory jurisdictions and has a reference to tables that store information related to designated addresses, contacts, and accounts for the different jurisdictions. S_ORG_EXT 906 provides general contact and account information to the site permit feature.

The site permit feature is available to all subscribers who minimally have “Read” access privilege to the site permit feature. Depending on access rights, the user may have fewer or more privileges to manipulate site permit information. The purpose of this system is to provide a general-purpose mechanism for relating site permit information to other types of records (or artifacts) as well as to provide access to site permit records. The relationship that a site permit information has to other information in the certification program is as important as the site permit information itself.

As a result of a search, the site permit information is presented to include relevant information regarding the permit for a particular site. That is important so that a user understands the context of the permit. The information presented includes options for modifying information regarding the permit. For example, options for changing or deleting a site record, if the user has the appropriate access privileges. The editing/adding screen provides fields that specify the permit number, the expiration date, the granting jurisdiction, the category for the permit, the description of the permit and the name on the permit holder. Similarly, a user can also select an option to delete a permit record.

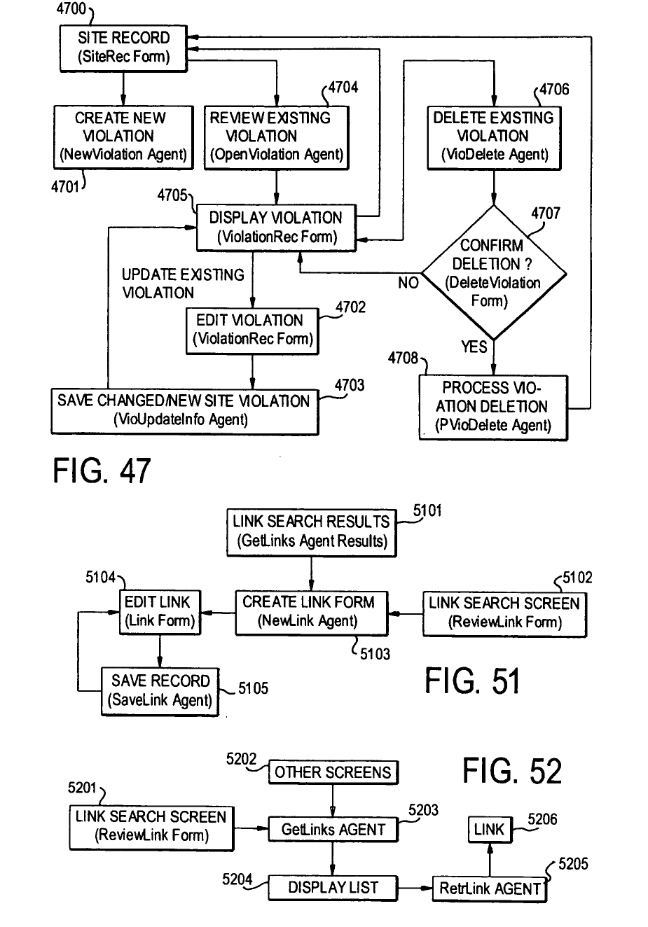

FIG. 47 is a flow diagram illustrating the violations feature of the certification program in accordance with an embodiment of the present invention. In step 4700, the user has access rights to view a site record in a SiteRec form. From there, the user can decide to create a new record or review the exiting record in more detail. In step 4701, the user creates a new record by invoking a NewViolation agent. The NewViolation agent is invoked from a violations record and uses parameters passed to it to generate a new violation record for the user. When generating the new record, the agent retrieves default values for applicable certifications and jurisdictions, which it uses to populate pick lists. The agent generates a form that embeds those pick lists, as well as keys to relate the new violation back to a site.

In step 4702, a ViolationRec form is populated with default values from the NewViolation agent and displayed for editing. In step 4703, the user then saves the record by invoking the VioUpdateInfo agent, which updates the database, updates the site permit displayed in the record itself and returns the user to the site permit record form. On the other hand, in step 4504, the user views the exiting document by invoking the OpenViolation agent, which then displays the record in a ViolationRec form in step 4705.

The OpenViolation agent is invoked from a list of Violation records by selecting the violation number of a violation. When called, the agent is passed the ID of an existing violation record, which it retrieves from the database and populates into the ViolationRec form. The form is displayed in a non-editing mode. The user must have the ability to “Read” or “Edit” violations information in order to execute this agent.

When viewing an existing record, a user also has the option to edit the record. If the user edits an existing record, the ViolationRec form is populated with existing information for that permit and is displayed for reviewing. In steps 4506-4508, a user can also decide to delete a record that is being displayed. A record is deleted by invoking a VioDelete agent, which creates a DeleteViolation form to confirm the deletion. If the user does not confirm the deletion, they are returned to the site permit record. If the deletion is confirmed, the PVioDelete agent is invoked, which processes the deletion, updates the displayed permit, and returns the user to the record.

FIG. 48 is a flow diagram illustrating the violations database tables used by the certification program in accordance with an embodiment of the present invention. The primary table used to implement the violations feature is CX_OU_VIOLATIONS 4801. The table is used to store information regarding violations and the permit in which the violation is based. Tables S_ORG_EXT 906 and CX_OU_PERMITS 4601 provide more general information to the violation feature such as contact and account information as well as site permit information.

A violation may be related to only a single site/property and a single site permit. Additionally, there may be many violations associated with a single site/property or site permit. Similar to the site permit feature, the violations feature is available to all subscribers who minimally have “Read” access privileges to the site permit feature. Depending on access rights, the user may have fewer or more privileges to manipulate site permit information. The purpose of the violations feature is to provide a general-purpose mechanism for relating violations information to other types of records (or artifacts) as well as to provide access to violations records. The relationship between violations information to other information in the certification program is as important as the violations information itself.

As a result of a search, the user is presented with a violation record. The top of the record includes information specific to a site location. The middle of the screen describes the permit that the violation is related to. When a violation is created, it is assumed that it is related to the most recent permit. From the screen, the user can either change or delete the violation information by selecting the appropriate options, or return to the site record. The editing/adding screen allows all of the various aspects of the violation to be documented. The user can then save the changes by selecting the appropriate option from the screen presented. A confirm message is displayed when the save operation is complete. Similarly, a user deletes the record by selecting the appropriate option from the screen and confirming the deletion.

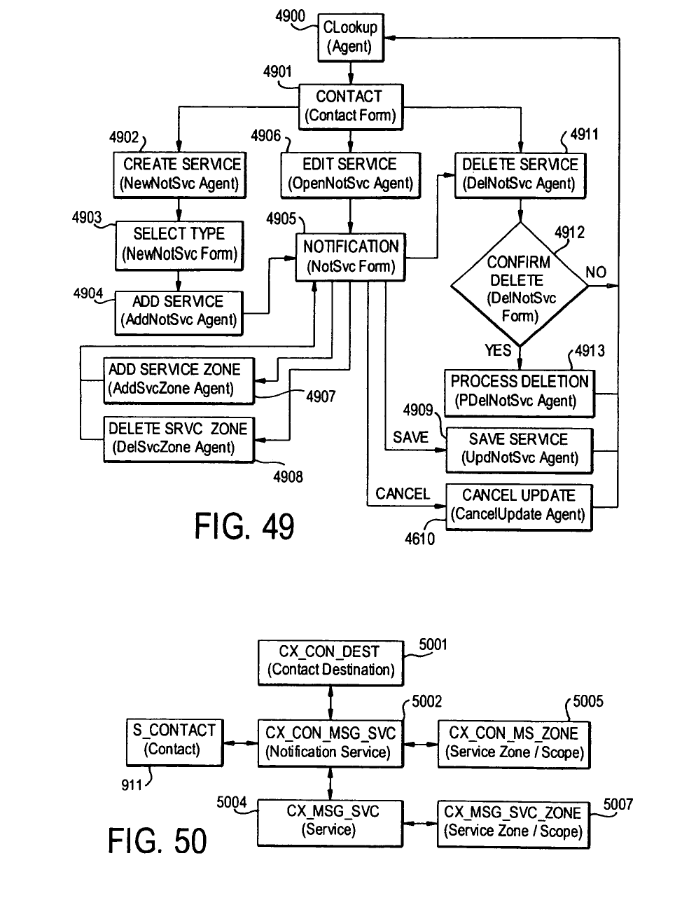

FIG. 49 is a flow diagram illustrating the notification service feature of the certification program in accordance with an embodiment of the present invention. A notification service is a predefined automated notification that is generated in response to the occurrence of a predetermined condition. In step 4900, a contact record is retrieved via the CLookup agent and displayed on a Contact form in step 4901. From within a contact record, a user with the appropriate access rights can create, view and maintain a notification service. In step 4902, the user creates a new notification service by invoking the NewNotSvc agent. The NewNotSvc agent is invoked from a notification service record and is used to select the available services that have not been defined for a contact. Once the user has selected a service, an agent is invoked to create a form where the new service can be defined in depth. The list of service notifications available and unused are queried, and displayed in a selection screen to the user.

Once a service notification is selected, the new service is created, and a notification service screen is displayed in the NotSvc form in step 4903. The new service is then added by invoking the AddNotSvc agent in step 4904. The AddNotSvc agent creates a contact notification service record in the database. A form is generated that allows the user to specify the details of that service. For example, the destination of the notification and the scope that is covered by the service.

In step 4906, the user can edit a notification service by invoking the OpenNotSvc agent. The OpenNotSvc agent is invoked from a list of notification service records within a contact record. When called, this agent is passed the ID of an existing service record, which it retrieves from the database. The agent displays a NotSvc form in a editing mode so that it can be updated. The user must have the ability to “Read” and “Edit” services in order to execute the agent.

When adding or editing a notification service, the user can modify the delivery method and destination of the notification as well as the scope of coverage of the notification. A notification is an automated message sent in response to an event of a particular type occurring in a specified zone. In steps 4907-4908, a user can add or delete a service zone by invoking the corresponding agents. In step 4905, the user can save the changes to the notification service by invoking the UpdNotSvc agent. On the other hand, a user can also cancel a change to notification services by invoking the CancelUpdate agent in step 4910.

In steps 4911-4913, a user can also decide to delete a notification service, in which case a confirmation screen is generated by the DelNotSvc agent. If the deletion is not confirmed, the user is returned to the contact record. The DelNotSvc form is used to display a confirmation message and solicit a response from the user. If the user elects to delete the record, it then invokes the PDelNotSvc agent to process that deletion. When the deletion is confirmed the PDelNotSvc agent updates the database.

FIG. 50 is a flow diagram illustrating the notification service database tables used by the certification program in accordance with an embodiment of the present invention. The primary database tables used to implement the notification service of the certification program are CX_CON_MSG_SVC 5002, CX_CON_MS_ZONE 5005, CX_CON_DEST 5001, CX_MSG_SVC 5004, CX_MSG_SVC_ZONE 5007. Table CX_CON_MSG_SVC 5002 is used to store contact service notification records. Those records relate to the specific service that is to be provided to a user at a specific time period. The records also include information regarding the destination for notifications. Table CX_CON_MS_ZONE 5005 is used to store information regarding the notification service zones. In other words, that information specifies the scope of the notification service. The information is used to specify the area that governs the activities to be monitored by the service. Each record in the table provides a key to the scope of the service, or the actual scope itself.

Table CX_CON_DEST 5001 is used to store alternative destinations for notification services. The notification can be delivered by letter, phone or e-mail. Table CX_MSG_SVC 5004 is used to store information regarding the definition of notification services. Each notification service is a discrete agent, which monitors some state. Based on that state, the agent creates some automated message. Table CX_MSG_SVC_ZONE 5007 is used to store information regarding zone/scope types that are allowed for each notification service defined in notification service database records.

The notification service feature is available to all certification program subscribers who minimally have “Read” access to the notification service feature. Depending on access rights, the user of the system has fewer or more privileges to manipulate notification services. The purpose of the feature is to provide a general-purpose mechanism for relating notification services to other types of records and to provide access to these notification services from contact records. The notification service information can be provided within the context of the contact that they are related to. Notification service records are visible in and accessed from associated contact records. If the user has “Read” access privileges to the information, and records of this type exist, the contact record will contain a listing of notification services.

Notification services are defined outside of certification program. Some services are created by integrating specialized codes into transactional systems. Others are implemented using periodically executed agents and programs. The generalized system for controlling where and how notifications are generated can be applied so broadly, that the systems that utilize the information can literally be anywhere and utilize a variety of different technologies.

When a search is conducted by a user, the user is presented with a screen that has a summary of information that is maintained with regard to each notification service offered by the certification program. The screen has three sections. The first defines the service, the second where the notifications are sent, and the third the “scope” that determines what is monitored to generate the type of notification in question.

From this screen the user can either change or delete the service by selecting the appropriate options, or return to the contact record. The major attributes of a notification service that can be modified are where the notification is sent, and the scope of the notification. In the section “Send Notification To” the user can either select an existing destination (for example, the default email address of the contact), they can specify one of the previously defined alternative destinations (which will be listed in a select box), or they can enter a new destination in the space underneath the select box. The types of destinations depend on the definition of the service, which is done outside the certification program environment.

By selecting the “Scope of Notification” option, the user can define the “zones” or areas that are covered by the service. Different services have different options for scope. The scope may limit the service to an event or activity that occurs involving a particular person, a specific site/property, a given subscription, an area code, a state, a zip code, or any combination thereof. The user can add or delete a zone by selecting the appropriate option from the screen. When the user elects to “Save Changes,” then the database is updated, the contact record is updated, and the user is returned to the contact screen. The “Notification Services” option allows a user to select the type of notification service. The user is not limited in the scope of the service, so more than one is really redundant.

FIG. 51 is a flow diagram illustrating the links management feature of the certification program in accordance with an embodiment of the present invention. In steps 5101-5102, a user while viewing a list of links, or while at the search link screen elects to create a new link. A NewLink agent is invoked for creating a new link in step 5103. The NewLink agent, after verifying user access, determines the relationship that is being created with the link to an existing site/property, contact or other record, and then opens a blank link form. The NewLink agent saves the context, and generates and displays a link form in the edit mode, in step 5104. The link form is the primary form used for editing or adding a link to the link management feature. When a new record is created the form is invoked in a blank state. When a record is being edited, the form is populated with the current information regarding that link. In step 5105, the user saves the link by invoking the SaveLink agent. The SaveLink agent is used for adding a new link to the link management feature, or updating an existing link.

FIG. 52 is a flow diagram illustrating the links management feature of the certification program in accordance with an embodiment of the present invention. In steps 5201-5202, a user enters search criteria in the ReviewLink search form. A GetLinks agent, using the entered search criteria as search parameters, invokes the search in step 5203. In step 5204, the Getlinks agent lists all the relevant links from the CX_LIBRARY table based other features of the certification program. For example, contact, site permits, participants, orders or the like. In step 5205, the user selects a link, which opens a new window and executes the RetrLink agent. That agent retrieves the URL address, and redirects the new window to the corresponding address.

FIG. 53 is a flow diagram illustrating the links management feature of the certification program in accordance with an embodiment of the present invention. In step 5301, the user retrieves a list of links using the Getlinks agent invoked from a search form or another record. In step 5302, the list of links is displayed. From that point, the user has the option to edit, delete or view a link. In step 5304, the user chooses to edit a link by invoking an EditLink agent. When the EditLink agent is called, the URL that is used to call it is parsed for parameters to indicate the link to be edited. After verifying user access, the agent opens the database, retrieves information about the link, populates a link form, and then loads the form for editing.

After editing, the user can either update the link or delete it. In steps 5305-5307, the user deletes the link. The DelLink agent is invoked from either a list of links, or from a single link. When invoked, the agent deletes the link and also determines where the user will be placed at the completion of the deletion. The agent also validates that the user has “delete” access privileges for the deletion action. The context information, along with basic information about the link being deleted, is placed in a DeleteLink form. The form is then presented to the user to confirm the deletion in step 5306. The DeleteLink form is used to confirm with the user that the link is to be deleted.

In step 5307, the user confirms the deletion and the PDeleteDoc agent processes the change to the database. Otherwise, the CDeleteDoc agent returns the user directly to the list. Instead of deleting a link, a user can also decide to save all changes made to the link. In step 5309, the user saves the changes to the link by invoking the SaveLink agent. Steps 5302-5309 can also be performed from a list of links presented to a user by invoking a ListRecs agent. It is contemplated by the invention that processing links records by invoking the ListRecs agent is done as part of the links management feature.

The primary tables used to implement the links management feature are the same database tables used to implement the data management feature as described in FIG. 30. To that end, the database tables perform a dual-purpose role for the certification program. The primary tables are CX_LIBRARY 3000, CX_LIB_CATEGORY 3001, and CX_LIB_CATS 3002. CX_LIBRARY 3000 is the principal table in the links management feature. The table 3000 contains detailed information regarding each link that is stored and used for listing and searching links. Table CX_LIB_CATS 3001 is the table used to store the categories that are assigned to the links within a subscription. Table CX_LIB_CATEGORY 3002 is used to store the assignment of categories to links within a subscription. In other words, the table 3002 contains information related to the intersection of tables CX_LIBRARY 3000 and CX_LIB_CATS 3001.

The links management feature is available to all subscribers who minimally have “Read” access to the links feature. It is contemplated by the invention that a specialized version of the link management feature can be used to serve “Customer Service” links, which are maintained in an administrative subscription, and are available to all users. Depending on the access rights, the user of that system has fewer or more privileges to manipulate links information. The purpose of the links management feature is to provide a general-purpose mechanism for relating links to other types of records in the program, providing access to links, and providing web-based access to links through a distributed architecture potentially involving multiple web-servers. Access to the feature can be provided directly from a main menu option.

When a search is initiated, a result screen is created based on the criteria (or lack thereof). That screen varies depending on whether the search was restricted to a category or not. If so, then the category column is omitted from the results, and the name of the category is included in the title of the screen (as illustrated in the Category Search Results screenshot below). The screen that is produced has greater or fewer options depending on the user's access rights. For example, if the user has “Edit” or “Delete” privileges, they will also have an “Action” column that allows them to perform those functions with links. On all search results screens, the user will see both the title, and the description of the link that was entered when the link was added to the system. The link itself can be viewed by clicking on the name (or title).

When that is done, a new window is opened and the link is opened in that window. When there are more than 10 links, the results are organized by “page” and there is a series of navigational controls at the bottom of the page that allow the user to go through the results. The paging mechanism for this search is the same as with all the features in the program, and is described elsewhere. If the user has “Edit/Add” rights, they have the option, from any search results screen, to edit the link entry. The screen is identical to the “Add a Link” screen with the exception that the category is pre-selected to the category that the link is currently assigned to. The user can change the category assigned by selecting an alternative or entering a new one.

If the user has “Delete” privileges, then they have the ability, again from the “Actions” column of any search results view, to remove the link from the system. That has the effect of deleting references to the link in the database. If that is the last link of a given category, the category will also be deleted. Once the delete option is selected, the user is asked to confirm the deletion. On doing so, the record is deleted from the database, the previously viewed list of links is updated, and the user is returned to that list.

Although illustrative embodiments have been described herein in detail, it should be noted and understood that the descriptions and drawings have been provided for purposes of illustration only and that other variations both in form and detail can be added thereupon without departing from the spirit and scope of the invention. The terms and expressions have been used as terms of description and not terms of limitation. There is no limitation to use the terms or expressions to exclude any equivalents of features shown and described or portions thereof.

1. A method for server-based management of a certification program for providing certification information to at least one subscriber, the certification program being implemented on a server that is searchable, the server including at least one processor, a memory and a plurality of agents logically connected to at least one database for providing requested certification information, the method comprising:
generating a user interface in a certification program environment that provides searchable certification information options based on predetermined access privileges granted to said subscriber;
executing a search request by said subscriber for certification information;
storing a plurality of search results containing certification information satisfying said search request;
displaying certification information to said subscriber for executing at least one certification-related procedure; and
storing new certification information related to said subscriber.

2. The method of claim 1, further comprising implementing a notification procedure for providing a notification to a subscriber regarding certification information and re-certification information related to a user.

3. The method of claim 1, wherein determining access privileges includes authenticating the identity of at least one user as a subscriber and determining access to certification information based on existing subscription information.

4. The method of claim 1, wherein access privileges include rights to read, delete, edit or output certification information.

5. The method of claim 1, wherein said access privileges are determined for every search query requested by a subscriber.

6. The method of claim 1, wherein the subscription information is used by other agents in the certification management program, the other agents comprising at least one agent related to notification services, at least one agent related to order services; at least one agent related to billing and collection services and at least agent related to maintaining subscription information.

7. The method of claim 6, wherein said subscription information is used for providing access privileges to certification information for a plurality of users listed under a subscription.

8. The method of claim 7, wherein the certification information is provisioned differently for each user listed under the subscription.

9. The method of claim 3, wherein access privileges are determined by evaluating use-of-rights tables and special privilege flags maintained in at least one database in communication with said server.

10. The method of claim 8, wherein the special privilege flags include privilege flags, site only flags, supervisor flags, participant and trainer flags and shared access flags.

11. The method of claim 1, wherein the displaying of certification information includes displaying embedded navigational links for navigating through certification information, wherein the navigational links are displayed in the context of other certification information displayed to the user.

12. The method of claim 1, wherein the displaying of certification information includes information for refining the search results.

13. The method of claim 1, wherein the certification information is displayed in a page format using a query caching mechanism of the certification program.

14. The method of claim 1, further comprising implementing an e-mail function on at least one search screen presented to the user, the e-mail function being used for communicating with other users or certification personnel while in the certification program environment.

15. The method of claim 1, wherein the storing of search results includes storing information related to previously used search screens.

16. The method of claim 4, wherein said certification information accessed by the user comprises account information, regulatory and state law information, order information, participant information, service request information, session information, trainer information, exam information and document management information.

17. The method of claim 16, wherein the account information, the regulatory and state law information, the order information, the participant information, the service request information, the session information, the trainer information, the exam information and the document management information are able to be accessed through the context of other certification information being displayed to the user in the certification program environment.

18. The method of claim 16, wherein the regulatory and state legal information is related to training and certification requirements for any one of the fifty U.S. states.

19. The method of claim 16, wherein the order information is related to training materials or certification materials ordered by at least one subscriber.

20. The method of claim 16, wherein the participant information is related to other subscribers using the certification program.

21. The method of claim 16, wherein the editing of service request information is related to updating contact information for at least one participant and at least one trainer.

22. The method of claim 16, wherein the service request information includes existing survey information, wherein the user is able read an existing survey or create a new survey related to a certification training session received by said user.

23. The method of claim 16, wherein training session information includes a statistical abstract for both exams and evaluations related to participation in a training session.

24. The method of claim 16, wherein the training session information includes exam information as well as information related to individual exam questions.

25. The method of claim 16, wherein the trainer session information includes a list of trainers for a selected training session.

26. The method of claim 16, wherein the exam information includes a list of exam questions, answers and scores in the context of a particular test taker or a venue for a particular exam.

27. The method of claim 16, wherein access to document management information includes rights for retrieving, deleting, editing, transferring and creating documents used by the certification program.

28. The method of claim 1, wherein the certification information includes trainer permit information, master trainer information, workshop information, contact information, supervisor information, report information, site permit information, violations information, notification service information, and link management information.

29. The method of claim 28, wherein the trainer permit information, the master trainer information, the workshop information, the contact information, the supervisor information, the report information, the site permit information, the violations information, the notification service information, and the link management information are able to be accessed through the context of other certification information being displayed to the user in the certification management environment.

30. The method of claim 28, wherein the trainer permit information is related to a trainer permit for providing education services through the grant of a license by a regulatory body.

31. The method of claim 30, wherein the trainer permit is granted for a particular training certification and jurisdictional area.

32. The method of claim 28, wherein the master trainer information is related to certification training taught by a trainer or taught in a workshop.

33. The method of claim 28, wherein the workshop information is related to a trainer and an exam used in a workshop.

34. The method of claim 28, wherein the master trainer information is related to a particular exam question used on an exam in a workshop.

35. The method of claim 28, wherein the contact information is related to participants, trainers and employers.

36. The method of claim 28, wherein the master trainer information is related to a relationship between at least one record and an account maintained by the certification program.

37. The method of claim 28, wherein the supervisor information is provided to a user with a supervisor flag, wherein the supervisor information is related to current users listed on a subscription.

38. The method of claim 28, wherein the record information is related to a report to be run, a time to run the report, parameters for running the report, a format for running the report, a destination for sending the report, and a mode for sending the report.

39. The method claim 28, wherein the site permit information is related to a site permit to provide training, wherein the site permit is related to a site location and a granting regulatory body in a jurisdictional area.

40. The method of claim 28, wherein the violations information is related to violations of a site permit for at a specific site location.

41. The method of claim 28, wherein the notification information is related to the scope, duration and delivery method of a notification service, wherein the notification is related to the occurrence of a predefined condition.

42. The method of claim 28, wherein the links management information is related to web-based links to certification information, wherein the links are provided to users listed on a subscription.

43. A method for server-based management of a certification program for providing certification information to at least one subscriber, the certification program being implemented on a server that is searchable, the server including at least one processor, a memory and a plurality of agents logically connected to at least one database for providing requested certification information, the method comprising:
authenticating at least one user requesting access to certification training information on the server;
determining access privileges to certification training information based on subscription information related to said user;
generating search options in a certification program environment that provides searchable certification information based on the determined access privileges;
generating a search screen for searching the certification training information based on said access privileges;
executing a search request by the user for certification training information;
storing a plurality of search results containing certification training information satisfying said search request;
displaying certification training information for executing at least one certification-related procedure; and
storing new certification information related to said user.

44. The method of claim 43, further comprising implementing a notification procedure for providing a notification regarding certification information and re-certification information related to a user.

45. The method of claim 43, wherein access privileges include rights to read, delete, edit or output certification information.

46. The method of claim 43, wherein said access privileges are determined for every search query request by a said user.

47. The method of claim 43, wherein the subscription information is used by other agents in the certification management program, the other agents comprising at least one agent related to notification services, at least one agent related to order services, at least one agent related to billing and collection services and at least agent related subscription services.

48. The method of claim 43, wherein said subscription information is used for providing access privileges to certification information for a plurality of users listed under a subscription.

49. The method of claim 43, wherein the certification information is provisioned differently for each user listed under the subscription.

50. The method of claim 43, wherein access privileges are determined by evaluating use-of-rights information and special privilege flags maintained in at least one database in communication with said server.

51. The method of claim 50, wherein the special privilege flags include privilege flags, site only flags, supervisor flags, participant and trainer flags and shared access flags.

52. The method of claim 43, wherein the displaying of certification information includes displaying embedded navigational links for navigating through certification information, wherein the navigational links are displayed in the context of other certification information displayed to the user.

53. The method of claim 43, wherein the displaying of certification information includes information for refining the search results.

54. The method of claim 43, wherein the certification information is displayed in a page format using a query caching mechanism of the certification program.

55. The method of claim 43, further comprising implementing an e-mail function on at least one search screen presented to the user, the e-mail function being used for communicating with other users or certification personnel while in the certification manager environment.

56. The method of claim 43, wherein the storing of search results includes storing information related to previously used search screens.

57. The method of claim 45, wherein said certification information accessed by the user comprises account information, regulatory and state law information, order information, participant information, service request information, session information, trainer information, exam information and document management information.

58. The method of claim 57, wherein the account information, the regulatory and state law information, the order information, the participant information, the service request information, the session information, the trainer information, the exam information and the document management information are able to be accessed through the context of other certification information being displayed to the user in the certification management environment.

59. The method of claim 57, wherein the regulatory and state legal information is related to training and certification requirements for any one of the fifty U.S. states.

60. The method of claim 57, wherein the order information is related to training materials or certification materials requested by a user.

61. The method of claim 57, wherein the participant information is in related to other users of the certification program.

62. The method of claim 57, wherein the editing of service request information includes updating contact information for at least one participant and at least one trainer.

63. The method of claim 57, wherein the service request information includes existing survey information, wherein the user is able read an existing survey or create a new survey related to participation in a certification training session.

64. The method of claim 57, wherein the training session information includes a statistical abstract for both exams and evaluations related to a training session.

65. The method of claim 57, wherein the training session information includes exam information as well as information related to individual exam questions.

66. The method of claim 57, wherein the trainer session information includes a list of trainers for a selected training session.

67. The method of claim 57, wherein the exam information includes a list of exam questions, answers and scores in the context of a particular test taker or a venue for a particular exam.

68. The method of claim 57, wherein access to document management information includes rights for retrieving, deleting, editing, transferring and creating documents used by the certification program.

69. The method of claim 43, wherein the certification information includes trainer permit information, master trainer information, workshop information, contact information, supervisor information, report information, site permit information, violations information, notification service information, and link management information.

70. The method of claim 69, wherein the trainer permit information, the master trainer information, the workshop information, the contact information, the supervisor information, the report information, the site permit information, the violations information, the notification service information, and the link management information are able to be accessed through the context of other certification information being displayed to the user in the certification management environment.

71. The method of claim 69, wherein the trainer permit information is related to a trainer permit for providing education services through the grant of a license by a regulatory body.

72. The method of claim 71, wherein the trainer permit is granted for a particular training certification and jurisdictional area.

73. The method of claim 69, wherein the master trainer information is related to certification training taught by a trainer or taught in a workshop.

74. The method of claim 69, wherein the workshop information is related to a trainer and an exam used in a workshop.

75. The method of claim 69, wherein the master trainer information is related to a particular exam question used on an exam in a workshop.

76. The method of claim 69, wherein the contact information is related to participants, trainers and employers.

77. The method of claim 69, wherein the master trainer information is related to a relationship between at least one record and an account maintained by the certification program.

78. The method of claim 69, wherein the supervisor information is provided to a user with a supervisor flag, wherein the supervisor information is related to current users listed on a subscription.

79. The method of claim 69, wherein the record information is related to a report to be run, a time to run the report, parameters for running the report, a format for running the report, a destination for sending the report, and a mode for sending the report.

80. The method claim 69, wherein the site permit information is related to a site permit to provide training, wherein the site permit is related to a site location and a granting regulatory body in a jurisdictional area.

81. The method of claim 69, wherein the violations information is related to violations of a site permit at a specific site location.

82. The method of claim 69, wherein the notification information is related to the scope, duration and delivery method of a notification service, wherein the notification is related to the occurrence of a predefined condition.

83. The method of claim 69, wherein the links management information is related to web-based links to certification information, wherein the links are provided to users listed on a subscription.

84. A system for server-based management of a certification program for providing certification information to at least one subscriber, the system comprising:
a network connection for providing user access to said certification program;
an authentication server for authenticating at least one user requesting access to certification training information;
at least one application server including,
a certification management unit containing a plurality of agents,
a memory,
at least one processor logically connected for providing certification information; and
at least one database in communication with said server for storing and maintaining certification information.

85. The system of claim 84, wherein said server determines access privileges to certification training information based on subscription information, right information and special privilege flags stored in said database related to said user requesting access.

86. The system of claim 84, wherein the network connection is an Internet connection.

87. The system of claim 84, wherein at least one agent in the certification management unit is operable for implementing within the certification program environment a login feature, an authentication feature, a subscription mechanism, a rights management mechanism, a query caching mechanism, a navigation mechanism, a privilege caching mechanism, a generic document management feature and an e-mail feature.

88. The method claim 84, wherein at least one agent within the certification management unit is operable for implementing within the certification program environment an account feature, a database feature, a participant feature, a service request feature, a session feature, a trainer feature and an exam feature.

89. The system of claim 88, wherein the certification information comprises account information, regulatory and state law information, order information, participant information, service request information, session information, trainer information; exam information and document management information.

90. The system of claim 84, wherein at least one agent in the certification management unit is operable for implementing within the certification program environment a trainer permit feature, a master trainer feature, a workshop feature, a contact feature, a supervisor feature, a report feature, a site permit feature, a violations feature, a notification feature, a document management feature and a links management feature.

91. The system of claim 90, wherein the certification information includes trainer permit information, master trainer information, workshop information, contact information, supervisor information, report information, site permit information, violations information, notification service information, and link management information.

92. The method of claim 90, wherein the report feature further includes a report definition and entitlement management component, a report request processing component, a file queuing, transfer and caching mechanism, the context assignment and report scheduling component, a user interface/presentation component.
